(19) United States
(12) Patent Application Publication
(10) Pub. No.: US 2023/0138791 A1
(43) Pub. Date: May 4, 2023

(54) FAN MODULE, AND PORTABLE AIR PURIFIER HAVING SAME

(71) Applicant: LG ELECTRONICS INC., Seoul (KR)

(72) Inventors: Sang Hyuk SON, Seoul (KR); Seok-Ho CHOI, Seoul (KR); Si Young OH, Seoul (KR); Juhyun KIM, Seoul (KR)

(21) Appl. No.: 17/802,738

(22) PCT Filed: Apr. 23, 2020
(86) PCT No.: PCT/KR2020/095075

§ 371 Date: Aug. 26, 2022

(30) Foreign Application Priority Data
Mar. 13, 2020 (KR) 10-2020-0031507

(51) Int. Cl. F04D 29/38; F04D 25/06; F04D 19/00; F04D 29/52; B01D 46/00

(52) U.S. Cl. CPC F04D 29/384; B01D 46/0047; F04D 19/002; F04D 25/06; F04D 29/522; B01D 2273/30

(57) ABSTRACT

Disclosed is an invention related to a fan module, and a portable air purifier having same. The disclosed invention has a front end protrusion part provided on the rotation-directional front end of a fan blade provided on a fan, wherein the front end protrusion part protrudes forward in the rotational direction, from the rotation-directional front end of the fan blade, and at least a portion of the front end protrusion part further protrudes forward in the rotational direction than a connection point of a shroud and the rotation-directional front end of the fan blade.

### TECHNICAL FIELD

Disclosed herein is a fan module for suctioning and discharging air and a portable air purifier having the same.

### BACKGROUND ART

Air purifiers are widely used in our daily lives. The devices can filter physical particles such as dust, fine dust, ultra fine dust and the like, chemical substances such as odorant particles, harmful gases and the like, and microorganisms such as germs, viruses and the like, in air, to purify the air.

People cannot live without air purifiers in an industrial society since more and more people are greatly affected by fine dust and suffer from allergies. Accordingly, there is a growing demand for the device.

Ordinarily, a large-sized air purifier is used in a house that is 100 square meters or greater. The air purifier can be provided with a filter for physical particles such as dust and the like, a filter for chemical substances such as gas and the like, and a filter for microorganisms such as germs, viruses and the like, in combination. That is, such a large-sized air purifier capable of accommodating various types of filters can be used in a large space.

However, air purifiers are rarely used in a narrow space such as a studio apartment, a space in a vehicle and the like, or in a very wide space such as a public library and the like or an outdoor space, considering space availability, portability and energy efficiency. Additionally, a user who moves from place to place usually uses an air purifier small enough to carry. Under the circumstances, there is a growing need for a portable air purifier that is easy to carry for use.

Portable air purifiers need to be small and lightweight enough for users to carry such that the users can easily carry and use the portable air purifiers anywhere. That is, the devices are useful for people who often go out and move from place to place instead of staying in a place such as a house.

The amount of purified air discharged from a portable air purifier is less than the amount of purified air discharged from an ordinary air purifier that is installed in a place. Additionally, the portable air purifier discharges purified forward in a narrower range than the ordinary air purifier. The portable air purifier has the above problems inherently, since the portable air purifier has a small size. As the size of the portable air purifier decreases, it is difficult to increase the amount of discharge of purified air and the range of forward discharge of purified air.

A decrease in the amount of discharge of purified air and the range of forward discharge of purified air of the portable air purifier makes it difficult for air purified by the portable air purifier to reach a user, in particular, a user’s face. The portable air purifier’s failure in reaching the user’s face means that the portable air purifier cannot provide air purification performance properly.

### DISCLOSURE

### Technical Problem

One objective of the present disclosure is to provide a fan module that is compact and lightweight and has an improved structure enabling purified air to reach a user’s face effectively and a portable air purifier including the fan module.

Another objective of the present disclosure is to provide a fan module that is easily molded using a mold and has excellent discharge performance and a portable air purifier including the fan module.

Still another objective of the present disclosure is to provide a fan module that ensures excellent discharge performance at fixed pressure and a portable air purifier including the fan module.

Yet another objective of the present disclosure is to provide a fan module that suppresses an increase in noise and also has excellent discharge performance and a portable air purifier including the fan module.

### Technical Solution

According to one aspect, in a fan module according to one aspect, a front end projection part is provided at a front end in a rotation direction of a fan blade included in a fan, and the front end projection part protrudes forward in the rotation direction from the front end of the fan blade in the rotation direction.

At least a part of the front end projection part may protrude further forward in the rotation direction than a connection point between the front end of the fan blade in the rotation direction and a shroud.

According to another aspect, a front end projection part is provided at a front end of a fan blade in a rotation direction provided in a fan, and the front end projection part protrudes forward in the rotation direction and toward one side in an axial direction from the front end of the fan blade in the rotation direction.

Accordingly, a shape of the fan blade may be designed in a way that an area of a region capable blowing of a larger amount of air than another region increases, and a stiffness of the fan blade is also improved.

Additionally, the front end projection part may not protrude further than the shroud toward one side in the axial direction, and a fan blade rear surface may be formed in a flat shape.

Accordingly, the shape of the fan blade may be changed without an increase of the number of molds used in molding of a conventional fan.

Additionally, according to another aspect, a fan blade front surface is formed in a shape which connects a leading edge and a trailing edge in a curved shape that is convex toward one side in an axial direction, and a fan blade rear surface is formed in a shape which connects the leading edge and the trailing edge straightly.

In a fan module having such a structure, as a camber is formed on only a front surface of a fan blade, molding using a mold is easily performed, and excellent discharge performance at fixed pressure may be provided.

According one aspect of the present disclosure, a fan module may include a shaft which extends in an axial direction; a motor which includes a stator and a rotor which rotates about the shaft; and a fan which includes a hub, a shroud, and a fan blade, wherein the hub may rotate along with the rotor and the shaft, the shroud may be disposed outside the hub in a radial direction, and the fan blade may protrude from the hub in a centrifugal direction and connect the hub and the shroud, wherein the fan may further include a front end projection part which protrudes forward in a rotation direction from a front end of the fan blade in the rotation direction, and at least a part of the front end projection part may protrude forward in the rotation direction further than a front end reference line which is a straight line which connects a connection point of the front end of the fan blade in the rotation direction and the hub and a connection point of the front end of the fan blade in the rotation direction and the shroud.

The fan blade may include a leading edge which is disposed at the front end in the rotation direction and formed to be straight; a trailing edge which is disposed at a rear end in the rotation direction and formed to be straight; a shroud chord which connects one end of the leading edge and one end of the trailing edge and extends in an inner circumferential surface of the shroud; and a hub chord which connects the other end of the leading edge and the other end of the trailing edge and extends in an outer circumferential surface of the hub, wherein the front end projection part may protrude from the leading edge and protrudes further forward than the shroud chord in the rotation direction.

The shroud chord may be obliquely formed with a predetermined slant angle in a way that the shroud chord is disposed at one side in the axial direction from the trailing edge side toward the leading edge side, and the front end projection part may form a slant angle parallel with the slant angle of the shroud chord and protrude from the leading edge, for example.

The front end projection part may be disposed in a way that a foremost side projection point of the front end projection part is closer to the shroud than the hub, for example.

The front end projection part may protrude further toward the one side in the axial direction as being closer to the foremost side projection point of the front end projection part from the other end side of the leading edge, for example.

The front end projection part may be formed in a way that the other end of the leading edge and the foremost side projection point of the front end projection part are roundly connected, for example.

The front end projection part may be formed into a curved shape convex toward the trailing edge side, for example.

The front end projection part may be formed in a shape in which a ratio of a distance between the foremost side projection point of the front end projection part and the hub and a distance between the foremost side projection point of the front end projection part and the shroud is in the range of 3:1 to 5:1, for example.

The fan blade may include a fan blade front surface and a fan blade rear surface each connecting the leading edge and the trailing edge, the fan blade front surface may be disposed further forward than the fan blade rear surface in the rotation direction, and the fan blade front surface and the fan blade rear surface may be formed into shapes different from each other, for example.

The fan blade front surface may be formed in a shape which connects the leading edge and the trailing edge into a curved surface that is convex toward one side in the axial direction, and the fan blade rear surface may be formed in a shape which connects the leading edge and the trailing edge straightly, for example.

The front end projection part may not protrude further than the shroud toward one side in the axial direction, for example.

The fan module may include a mixed flow fan which suctions air in the axial direction and discharges the air in a direction between the axial direction and the radial direction, for example.

According to another aspect of the present disclosure, a portable air purifier may include a case in which a suction surface is disposed at one side in an axial direction and a discharge surface is disposed at the other side in the axial direction; a filter disposed between the suction surface and the discharge surface; and a fan module disposed between the discharge surface and the filter, wherein the fan module may include: a shaft which extends in the axial direction; a motor which includes a stator and a rotor which rotates about the shaft; and a fan which includes a hub, a shroud, and a fan blade, wherein the hub may rotate along with the rotor and the shaft, the shroud may be disposed outside the hub in a radial direction, and the fan blade may protrude from the hub in a centrifugal direction and connect the hub and the shroud, the fan may further include a front end projection part which protrudes forward in a rotation direction from a front end of the fan blade in the rotation direction, and at least a part of the front end projection part may protrude forward in the rotation direction further than a front end reference line which is a straight line which connects a connection point of the front end of the fan blade in the rotation direction and the hub and a connection point of the front end of the fan blade in the rotation direction and the shroud.

### Advantageous Effects

A portable air purifier according to the present disclosure is provided with a fan having the same weight and size as an axial flow fan and capable of discharging purified air to a wider area and farther away than the axial flow fan. The portable air purifier is compact and lightweight, allows purified air to reach a user’s face effectively, and ensures improvement in air purification performance.

In addition, the present disclosure provides a fan module that is easily molded using molds and has excellent discharge performance by changing a shape of a fan blade without an increase of the number of molds that are conventionally used for molding a fan so as to increase an air contact area of the fan blade and improve the rigidity of the fan blade and the performance of the fan blade at fixed pressure.

Further, the present disclosure provides excellent discharge performance at fixed pressure while easily molding using the molds by forming a camber on a front surface of the fan blade.

Furthermore, according to the present disclosure, the shape of the fan blade is designed in a way that an area of a region that blows a larger amount of air than other regions expands and the rigidity of the fan blade is improved.

Thus, according to the present disclosure, the portable air purifier capable of suppressing an increase in noise and having excellent discharge performance is provided.

### DESCRIPTION OF DRAWINGS

FIG. 1 is a front perspective view showing the front surface side of a portable air purifier of one embodiment.

FIG. 2 is an exploded perspective view showing a state in which the portable air purifier in FIG. 1 is exploded.

FIG. 3 is rear perspective view showing the rear surface side of the portable air purifier in FIG. 1.

FIG. 4 is a cross-sectional view along line “IV-IV” in FIG. 1.

FIG. 5 is a front perspective view separately showing a case in FIG. 1.

FIG. 6 is a rear perspective view separately showing the case in FIG. 1.

FIG. 7 is a cross-sectional view specifically showing the structure of portion “VII” in FIG. 4.

FIG. 8 is a perspective view separately showing a fan module of one embodiment.

FIG. 9 is a perspective view separately showing a fan case in FIG. 8

FIG. 10 is a front view separately showing the fan in FIG. 8.

FIG. 11 is a side view showing the fan in FIG. 10.

FIG. 12 is a cross-sectional view along line “X II - X II” in FIG. 11.

FIG. 13 is an exploded perspective view separately showing a fan cover and a fan module.

FIG. 14 is an exploded perspective view separately showing a fan module, a fan base and a filter.

FIG. 15 is a rear perspective view showing the rear surface of a fan base.

FIG. 16 is a perspective view showing a coupling state between the fan base and the filter.

FIG. 17 is a view showing an aspect of the air flow of the portable air purifier of one embodiment.

FIG. 18 is a front perspective view showing a front surface side of a fan provided in a portable air purifier of another embodiment.

FIG. 19 is a rear perspective view showing a rear surface side of the fan in FIG. 18.

FIG. 20 is a front view showing the front surface side of the fan in FIG. 18.

FIG. 21 is an enlarged view showing portion “XXI” in FIG. 20.

FIG. 22 is an enlarged view showing portion “XXII” in FIG. 21.

FIG. 23 is a cross-sectional view along line “XXIII-XXIII” in FIG. 20.

FIG. 24 is a front view showing a slide direction of a mold used for molding the fan of another embodiment.

FIG. 25 is a side cross-sectional view showing the slide direction of the mold in FIG. 24.

FIG. 26 is a graph showing a measurement result of a flow rate with respect to a fan speed of the portable air purifier of another embodiment.

FIG. 27 is a graph showing a measurement result of a noise with respect to the flow rate of the portable air purifier of another embodiment.

### MODES OF THE INVENTION

The above-described aspects, features and advantages are specifically described hereunder with reference to the accompanying drawings such that one having ordinary skill in the art to which the present disclosure pertains can easily embody the technical spirit of the disclosure. In the disclosure, detailed description of known technologies in relation to the subject matter of the disclosure is omitted if it is deemed to make the gist of the disclosure unnecessarily vague. Below, preferred embodiments according to the disclosure are specifically described with reference to the accompanying drawings. In the drawings, identical reference numerals can denote identical or similar components.

The terms “first”, “second” and the like are used herein only to distinguish one component from another component. Thus, the components should not be limited by the terms. Certainly, a first component can be a second component unless stated to the contrary.

When one component is described as being “in the upper portion (or the lower portion)” or “on (or under)” another component, one component can be directly on (or under) another component, and an additional component can be interposed between the two components.

When any one component is described as being “connected”, “coupled”, or “connected” to another component, any one component can be directly connected or coupled to another component, but an additional component can be “interposed” between the two components or the two components can be “connected”, “coupled”, or “connected” by an additional component.

Throughout the disclosure, each component can be provided as a single one or a plurality of ones, unless stated to the contrary.

In the disclosure, singular forms include plural forms as well, unless explicitly indicated otherwise. It is to be understood that the terms such as “comprise” or “include” and the like, when used in this disclosure, are not interpreted as necessarily including stated components or steps, but can be interpreted as excluding some of the stated components or steps or as further including additional components or steps.

Throughout the disclosure, the terms “A and/or B” as used herein can denote A, B or A and B, and the terms “C to D” can denote C or greater and D or less, unless stated to the contrary.

### First Embodiment of Portable Air Purifier

### Exterior of Portable Air Purifier

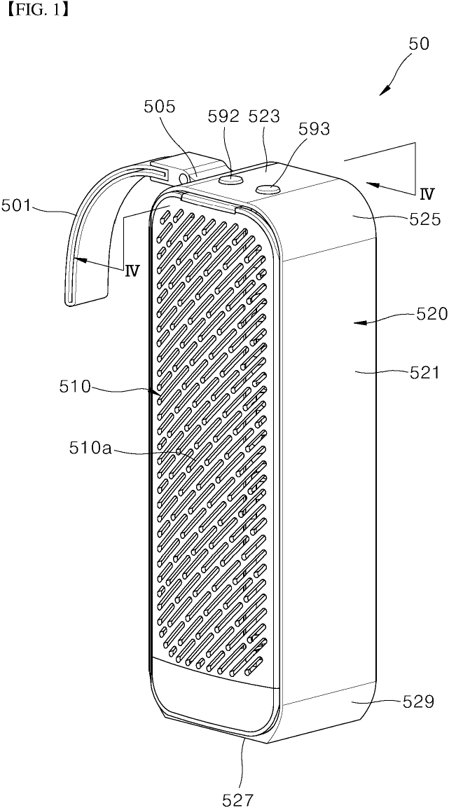

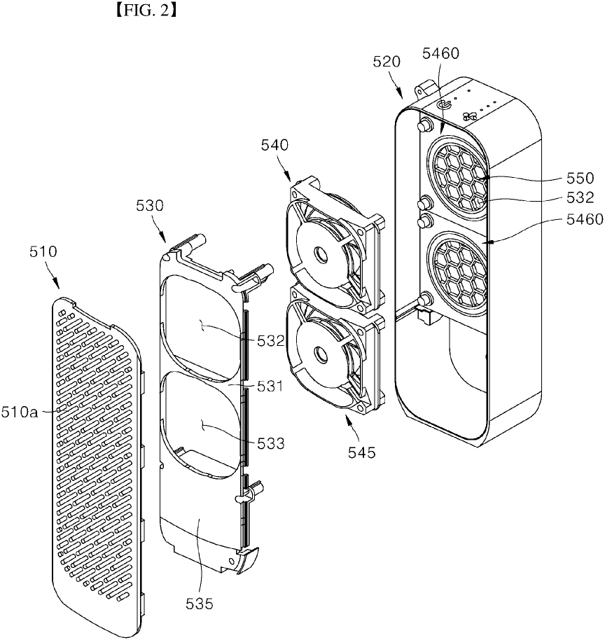

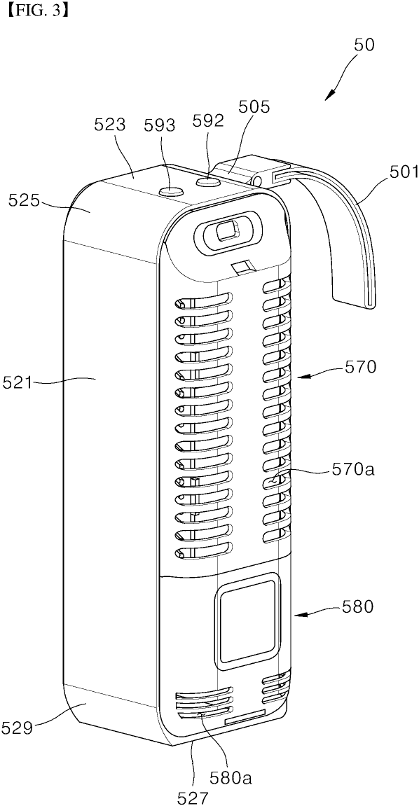

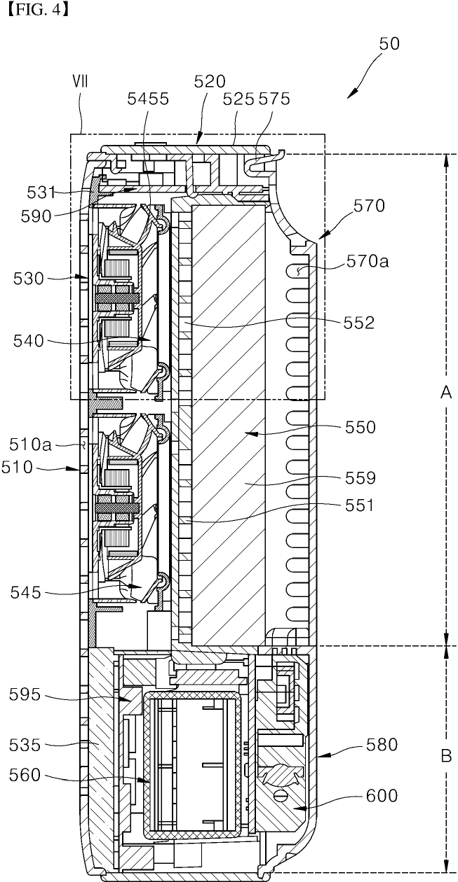

FIG. 1 is a front perspective view showing the front surface side of a portable air purifier of one embodiment, and FIG. 2 is an exploded perspective view showing a state in which the portable air purifier in FIG. 1 is exploded. FIG. 3 is rear perspective view showing the rear surface side of the portable air purifier in FIG. 1, and FIG. 4 is a cross-sectional view along line “IV-IV” in FIG. 1.

In the embodiment, a portable air purifier 50 is described as an example.

Referring to FIGS. 1 to 4, the portable air purifier 50 in the embodiment may be approximately formed into a cuboid. The portable air purifier 50 includes a case 520, a front surface panel 510 and a rear surface panel 570.

The case 520 forms the skeleton of the exterior of the portable air purifier 50. Various types of components are accommodated in the case 520.

Both sides of the case 520 in a first direction may be open. That is, the front and the rear of the case 520 may be open. A suction surface may be disposed on one side of the case 520 in the first direction, and a discharge surface may be disposed on the other side of the case 520 in the first direction.

For example, the suction surface may be disposed at the rear of the case 520, and the rear surface panel 570 may be disposed at the rear of the case 520, where the suction surface is disposed. Additionally, the discharge surface may be disposed at the front of the case 520, and the front surface panel 510 may be disposed at the front of the case 520, where the discharge surface is disposed.

The suction surface may indicate a virtual surface corresponding to the boundary between the inside of the case 520 and the outside of the case 520, at the rear of the case 520. The discharge surface indicates a virtual surface corresponding to the boundary between the inside of the case 520 and the outside of the case 520, at the front of the case 520.

In the embodiment, the suction surface and the discharge surface may actually be openings formed at the rear and the front of the case 520, since both the rear and the front of the case 520 are open. In the embodiment, the suction surface and the discharge surface are disposed in parallel, for example.

The front surface panel 510 is coupled to the front of the case 520. The front surface panel 510 forms the exterior of the front surface of the portable air purifier 50.

The rear surface panel 570 is coupled to the rear of the case 520. The rear surface panel 570 forms the exterior of the rear surface of the portable air purifier 50.

The portable air purifier 50 may be entirely formed into a standing cuboid that is elongated in the up-down direction. Accordingly, a user may use the portable air purifier 50 in the state in which the portable air purifier 50 stands or lies. Additionally, the portable air purifier 50 may stay in the same position reliably without rolling in a moving vehicle, even if the portable air purifier 50 is used in the state in which the portable air purifier 50 lies.

Directions are defined as follows. A direction from the case 520 to the front surface panel 510 is referred to as a front, and a direction from the case 520 to the rear surface panel 570 is referred to as a rear. At this time, a “first direction” denotes the front-rear direction. Additionally, the first direction may have the same meaning as the axial direction. The axial direction may be defined as a parallel direction with the lengthwise direction of a shaft disposed at a fan module 540 that is described below. A “second direction” is a direction perpendicular to the first direction and denotes the left-right direction. A “third direction” is a direction perpendicular to the first direction and the second direction and denotes the up-down direction.

### Entire Structure of Portable Air Purifier

The portable air purifier 50 in the embodiment includes a front surface panel 510, a case 520, a fan cover 530, a fan module 540, 545, a filter module 550, a battery 560, a rear surface panel 570 and a rear surface cover 580.

The front surface panel 510 is disposed at the foremost side of the portable air purifier 50 and forms the exterior of the front surface of the portable air purifier 50. Air purified by the portable air purifier 50 is discharged outward through the front surface panel 510. To this end, a plurality of outlets 510a is provided on the front surface panel 510.

The case 520 forms the skeleton of the exterior of the portable air purifier 50. The exteriors of the upper surface, lateral surfaces and lower surface of the portable air purifier 50 are formed by the case 520. Accommodation space is formed in the case 520. Various types of components such as a fan cover 530, a fan module 540, 545, a battery 550, a filter module 560 and the like, constituting the portable air purifier 50, are accommodated in the accommodation space. The case 520 has enough strength to protect the accommodated components from an external impact, for example.

The fan cover 530 is accommodated in the accommodation space of the case 520 and disposed at the front of the fan module 540, 545. That is, the fan cover 530 is disposed between the front surface panel 510 and the fan module 540, 545, inside the case 520.

The fan cover 530 fixes the fan module 540, 545 to the inside of the case 520. Additionally, the fan cover 530 also induces air being blown by the fan module 540, 545 to flow straight toward the front, without causing the spread of the air to surrounding areas. Further, the fan cover 530 may be involved in fixing the filter module 550 and the battery 560.

The fan module 540, 545 may be accommodated in the accommodation space of the case 520, and disposed between the discharge surface and the filter module 550. Specifically, the fan module 540, 545 may be disposed between the fan cover 530 and the filter module 550. That is, the fan module 540, 545 is disposed at the rear of the fan cover 530 and the front of the filter module 550. The fan module 540, 545 suctions air from the rear of the portable air purifier 50 and discharges air to the front of the portable air purifier 50.

In the embodiment, the fan module 540, 545 includes a mixed flow fan respectively, for example. The fan module 540, 545 may suction air having passed through the filter module 550 in the axial direction and discharge the air in a direction between the axial direction and the radial direction.

The filter module 550 is accommodated in the accommodating space of the case 520 and disposed between the fan module 540, 545 and the rear surface panel 570. That is, the filter module 550 is disposed at the rear of the fan module 540, 545 and the front of the rear surface panel 570.

The filter module 550 purifies air suctioned through the rear of the portable air purifier 50. The air that is purified while passing through the filter module 550 passes through the fan module 540, 545, the fan cover 530 and the front surface panel 510 and then is discharged from the front of the portable air purifier 50.

The filter module 550 may include a filter case 551 and a filter 559.

The filter case 551 forms the skeleton of the exterior of the filter module 550. In the embodiment, the filter case 551 is formed into a cuboid, the rear surface of which is open, for example. Insertion space for accommodating the filter 559 is formed in the filter case 551. The rear of the filter case 551 is open. Accordingly, a passage for inserting the filter 559 into insertion space in a case main body part 552 is formed.

The filter 559 is mounted in the insertion space of the filter case 551. The filter case 551 may be provided with a mounting groove or a mounting projection that allows the filter 559 to be firmly mounted in the filter case 551, on the inner surface thereof.

Additionally, the filter case 551 is provided with a penetration hole 552 that forms a passage between the insertion space and the fan module 540, 545. The penetration hole 552 is formed in a way that penetrates in the front-rear direction on the front surface of the filter case 551. The penetration hole 552 forms a passage for allowing air having passed through the filter 559 to flow toward the fan module 540, 545.

A plurality of penetration holes 552 is formed on the front surface of the filter case 551, and each of the penetration holes 552 is formed in a way that penetrates in the front-rear direction on the front surface of the filter case 551.

In the embodiment, a plurality of penetration holes 552 is provided on the front surface of the filter case 551, and each penetration hole 552 is formed into a hexagon, for example. The plurality of penetration holes 552 is arranged in the form of a honeycomb. Accordingly, a honeycomb structure may be formed on the front surface of the filter case 551.

The honeycomb structure, formed on the front surface of the filter case 551 as described above, ensures improvement in the rigidity of the filter case 551, makes the filter case 551 lightweight as well as ensuring a passage for allowing air to flow.

The battery 560 is accommodated in the accommodation space of the case 520, and disposed under the fan module 540, 545 and the filter module 550. The battery 560 can supply a power source for driving the portable air purifier 50. To this end, the battery 560 may be electrically connected to the fan module 540, 545, the filter module 550 and at least one of a sub PCB 590 and a main PCB 595 that are described below.

Together with the rear surface cover 580, the rear surface panel 570 is disposed at the rearmost side of the case 520 and forms the exterior of the rear surface of the portable air purifier 50. The rear surface panel 570 is disposed behind the filter module 560. External air is suctioned into the portable air purifier 50 through the rear surface panel 570. To this end, the rear surface panel 570 has a plurality of first inlets 570a, thereon.

Additionally, together with the rear surface panel 570, the rear surface cover 580 is disposed at the rearmost side of the case 520 and forms the exterior of the rear surface of the portable air purifier 50. The rear surface cover 580 is disposed behind the battery 560. In the embodiment, the area behind the filter module 550 is covered by the rear surface panel 570. The area behind the battery 560 is covered by the rear surface cover 580.

The rear surface cover 580 may have a second inlet 580a. The second inlet 580a is formed in a way that penetrates on the rear surface cover 580. The second inlet 580a forms a passage connecting among the rear of the case 520, the battery 560 and a sensor module 600. Through the second inlet 580a, external air may flow to the battery 560 and the sensor module 600 in a second area B.

### Structure of Case

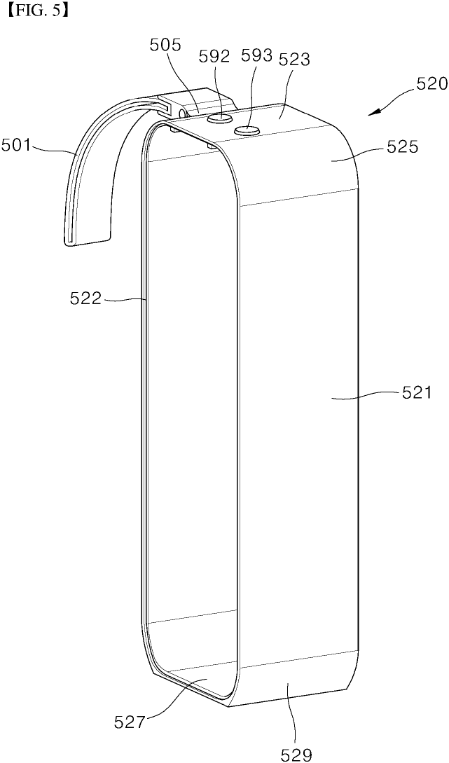

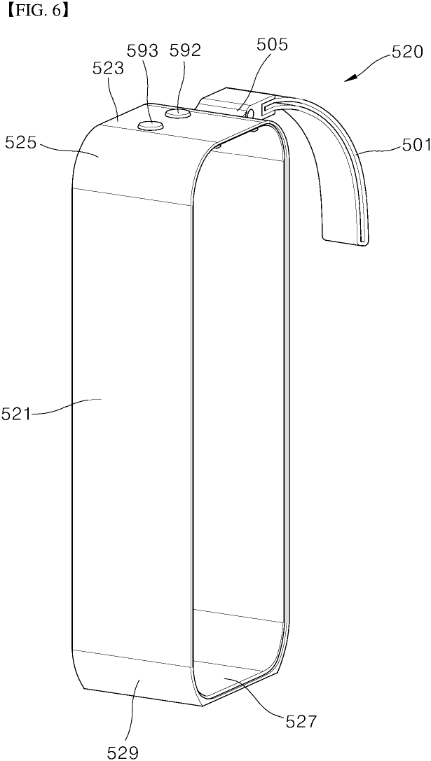

FIG. 5 is a front perspective view separately showing a case in FIG. 1, and FIG. 6 is a rear perspective view separately showing the case in FIG. 1.

Referring to FIGS. 3, 5 and 6, the portable air purifier 50 includes a case 520 that forms the skeleton of the exterior of the portable air purifier 50. The case 520 has accommodation space therein, and one side and the other side of the accommodation space in the first direction are open.

Directions are defined as follows. A direction from the case 520 to the front surface panel 510 is referred to as a front, and a direction from the case 520 to the rear surface panel 570 is referred to as a rear. At this time, a “first direction” denotes the front-rear direction. A “second direction” is a direction perpendicular to the first direction and denotes the left-right direction. A “third direction” is a direction perpendicular to the first direction and the second direction and denotes the up-down direction.

In the embodiment, the case 520 is formed into a cuboid having the front surface and the rear surface that are open, and therein, has accommodation space having the front and the rear that are open. The case 520 may be made of a metallic material. In the embodiment, the case 520 is made of a material such as aluminum that is lightweight and has high strength, for example.

The rear surface of the case 520 is open to suction external air. The front surface of the case 520 is open to discharge air purified in the accommodation space of the case 520. Through the open front surface and the open rear surface of the case 520, various types of components constituting the portable air purifier 50 may be installed in the accommodation space of the case 520.

A filter module 550 may be mounted in the case 520 or detached from the case 520 through the open rear surface of the case 520. The rear surface panel 570 is coupled to the open rear surface of the case 520. The rear surface panel 570 coupled to the case 520 covers the open rear surface of the case 520.

The case 520 may include a first surface part 521, a second surface part 523, a first connection surface part 525, a third surface part 527, and a second connection surface part 529, while being formed into a cuboid having the front surface and the rear surface that are open.

The first surface part 521 forms a surface in a direction that is perpendicular to the second direction perpendicular to the first direction. That is, the first surface part 521 forms a lateral surface of the case 520. The first surface part 521 is formed into a vertical flat surface that forms a wall covering a lateral portion of the accommodation space in the case 520.

The case 520 has a pair of first surface parts 521, and the first surface parts 521 face each other and are spaced a predetermined distance apart from each other. At this time, the pair of first surface parts 521 is disposed in the second direction, i.e., a direction in which the first surface parts 521 are disposed side by side in the left-right direction.

The second surface part 523 forms a surface in a direction that is perpendicular to the third direction and is disposed at one side of the pair of first surface parts 521 in the third direction. That is, the second surface part 523 is disposed in the upper portion of the first surface part 521, and forms a flat surface in a direction parallel with the direction in which the first surface parts 521 are spaced, i.e., a horizontal flat surface. The second surface part 523 forms the upper surface of the case 520.

The first connection surface part 525 is disposed between the first surface part 521 and the second surface part 523. The first connection surface part 525 is disposed respectively between the end portion of one side of the second surface part 523 and the first surface part 521 below the end portion of one side of the second surface part 523, and between the end portion of the other side of the second surface part 523 and the first surface part 521 below the end portion of the other side of the second surface part 523.

Each of the first connection surface parts 525 connects the first surface part 521 and the second surface part 523 in a rounded manner. The first connection surface part 525 makes an upper edge of the case 520, at which the first surface part 521 and the second surface part 523 connect, round, improving the safety of a product and the aesthetic qualities of the exterior of a product.

The third surface part 527 is disposed below the second surface part 523 and the first surface part 521, and forms a flat surface parallel with the second surface part 523. The third surface part 527 forms the lower surface of the case 520. Additionally, the third surface part 527 is a portion that supports the portable air purifier 50 such that the portable air purifier 50 keeps standing.

The second connection surface part 529 is disposed between the first surface part 521 and the third surface part 527. The second connection surface part 529 is disposed respectively between the end portion of one side of the third surface part 527 and the first surface part 521 over the end portion of one side of the third surface part 527, and between the end portion of the other side of the third surface part 527 and the first surface part 521 over the end portion of the other side of the third surface part 527.

Each of the first connection surface parts 525 connects the first surface part 521 and the second surface part 523 in a rounded manner. The first connection surface part 525 makes an upper edge of the case 520, at which the first surface part 521 and the third surface part 527 connect, round, improving the safety of a product and the aesthetic qualities of the exterior of a product.

The case 520 may have a power button 592 in the upper portion thereof, i.e., in the second surface part 523 of the case 520. The power button 592 is provided as a manipulation button for turning on/off the portable air purifier 50.

Additionally, the case 520 may have an air volume control button 593, in the upper portion thereof. The air volume control button 593 is provided as a manipulation button for increasing or decreasing the air volume of the portable air purifier 50. The air volume control button 593 may be disposed near the power button 592 such that the user identifies and manipulates the air volume control button 593 readily.

Further, the case 520 may have a strap mounting part 505 for coupling the strap 501 to the case 520. The strap 501 is provided to allow the user to hold the case 520. The user can move up the portable air purifier 50 by holding the strap 501 without directly holding the portable air purifier 50. That is, the strap 501 helps to improve the portability of the portable air purifier 50.

The accommodation space in the case 520 may be divided into a first area A and a second area B. When the accommodation space is divided in the up-down direction, the upper area is the first area A, and an area under the first area A is the second area B. The first area A and the second area B are divided conceptually rather than physically.

In the embodiment, among the components accommodated in the accommodation space, the fan modules 540, 545 and the filter module 550 are disposed in the first area A, and the battery 550 is disposed in the second area B.

### Disposition Structure of Components of Portable Air Purifier

Referring to FIGS. 1 to 4, the accommodation space in the case 520 forming the skeleton of the portable air purifier 50 is divided into a first area A in the upper portion of the case 520 and a second area B in the lower portion of the case 520.

Components in relation to the suction, purification and discharge of air are disposed in the first area A. That is, the filter module 550 and the fan module 540, 545 are disposed in the first area A, and accordingly, air flows in the first area A. A plurality of first inlets 570a is provided as a passage for suctioning air, on the rear surface panel 570. An air discharge part 532, 533 and an outlet 510a are provided as a passage for discharging air purified in the first area A, on the fan cover 530 and the front surface panel 510. Additionally, a flow path connecting among the first inlet 570a, the air discharge part 532, 533 and the outlet 510a is formed in the first area A.

That is, the first inlet 570a, the filter module 550, the fan module 540, 545, the air discharge part 532, 533 and the outlet 510a are provided in the first area A, and a flow path for allowing air suctioned into the portable air purifier 50 to pass through the air purifier 50 is formed in the first area A.

Components that do not directly relate to an air flow for air purification are disposed in the second area B. That is, the main PCR 595, the battery 560 and the sensor module 600 are disposed in the second area B. The rear cover 580 covers the open rear of the space where the above components are disposed.

In the embodiment, the case 520 is formed in to a cuboid having a length in the up-down direction greater than a length in the lateral direction. Additionally, the up-to-down length of the first area A in the upper portion of the case 520 is greater than that of the second area B in the lower portion of the case 520. That is, when the portable air purifier 50 stands vertically, the first area A in the upper portion of the case 520 occupies more space than the second area B in the lower portion of the case 520.

A lower cover part 535 of the fan cover 530 is disposed at the frontmost side of the second area B. The battery 560 is disposed behind the lower cover part 535 while being disposed in the second area B. The fan module 540, 545 and the filter module 550 are disposed over the battery 560, and the rear surface cover 580 is disposed behind the battery 560. Additionally, the sensor module 600 may be disposed between the battery 560 and the rear surface cover 580.

That is, the upper boundary of the battery 560 is defined by the fan module 540, 545 and the filter module 550, the lateral and lower boundaries of the battery 560 are defined by the first surface part 521 and the third surface part 527 of the case 520, and the rear boundary of the battery 560 is accommodated in space defined by the rear surface cover 580.

In the embodiment, the battery 560 is a heavier object than the fan module 540, 545 and the filter module 550. It is preferable that the battery 560 weights more than a total weigh of the fan module 540, 545 and the filter module 550.

Ordinarily, since the weight per unit volume of the battery 560 is much greater than that of the fan module 540, 545 and that of the filter module 550, the battery 560 may be readily provided as a heavier object than the fan module 540, 545 and the filter module 550 although the weight or size of the battery 560 does not increase intentionally.

That is, even if a battery 560 having capacity required for the ordinary use of an portable air purifier 50 is applied to the portable air purifier 50, naturally, the battery 560 weights more than the fan module 540, 545 and the filter module 550.

When the battery 560 as a heavy object is disposed in the lower portion of the portable air purifier 50, the following effects can be produced.

First, when the battery 560 that is a heavy object is disposed in the lower portion of the portable air purifier 50, the center of gravity of the portable air purifier 50 is biased toward the lower side of the portable air purifier 50 from the up-to-down center of the portable air purifier 50. That is, the center of gravity of the portable air purifier 50 is biased toward the lower side of the portable air purifier 50, in which the battery 560 is disposed.

The bias of the center of gravity of the portable air purifier 50 toward the lower portion of the portable air purifier 50, where the battery 560 is disposed, reduces the risk of the overturning of the portable air purifier 50, when the portable air purifier 50 stands vertically.

That is, when the portable air purifier 50 stands vertically, the portable air purifier 50 rarely falls since the center of gravity of the portable air purifier 50 is at the lower side of the portable air purifier 50 because of the battery 560 in the lower portion of the portable air purifier 50.

When it comes to the portable air purifier 50 in the embodiment, the third surface part 527 of the case 520 forms a flat surface having a greater surface area than the second surface part 523 of the case 520. That is, the third surface part 527 forms a long flat surface that has a greater length in the lateral direction than the second surface part 523. That is, under the assumption that the length of the third surface part 527 in the lateral direction is d1 and that the length of the upper surface part 527 in the lateral direction is d2, the relationship d1>d1 is satisfied. Additionally, the second connection surface part 529 connecting the third surface part 527 and the first surface part 521 forms a curved surface that has a less R value than the first connection surface part 525.

The third surface part 527 of the case 520 is a portion contacting the bottom surface of the portable air purifier 50 when the portable air purifier 50 stands vertically. That is, the third surface part 527 is a portion that supports the portable air purifier 50 such that the portable air purifier 50 keeps sanding.

Since the third surface part 527 of the case 520 forms a surface area that has a greater surface area than the second surface part 523, the third surface part 527 of the case 520 can support the portable air purifier 50 that stands vertically, more reliably.

In combination of the structure in which the battery 560 is disposed in the lower portion of the portable air purifier 50 such that the center of gravity of the portable air purifier 50 is at the lower side of the portable air purifier 50, and the structure in which the third surface part 527 of the case 520, which supports the portable air purifier 50 standing vertically, forms a flat surface that has a greater surface area than the second surface area 523, effectively suppressing the overtraining of the portable air purifier 50 and reliably keeping the portable air purifier 50 standing vertically.

Second, when the battery 560 as a heavy object is disposed in the lower portion of the portable air purifier 50, the other components such as the filter module 550 and the fan module 540, 545 constituting the portable air purifier 50 need to be disposed further upward than the battery 560. That is, components in relation to the suction, purification and discharge of air need to be disposed further upward than the battery 560.

To ensure the charge capacity of the battery 560, required for the smooth operation of the portable air purifier 50, the battery 560 needs to have a predetermined size or greater. It means that the portable air purifier 50 needs to have installation space of a predetermined size or greater, therein, to install the battery 560. Additionally, it is irrational to form a flow path for allowing an air to flow in the space where the battery 560 is installed. Accordingly, components in relation to the suction, purification and discharge of air needs to be disposed to avoid the battery 560, i.e., in a position higher than the position of the battery 560.

In the disposition structure, a flow path for the suction, purification and discharge of air is formed in the first area A higher than the position of the battery 560, in the portable air purifier 50. Thus, the suction of air into the portable air purifier 50, and the discharge of air purified in the portable air purifier 50 are performed in a position higher than the position of the battery 560.

As purified air is discharged from the upper portion of the portable air purifier 50, the air purified in the portable air purifier 50 can reach the user’s face more easily.

When the portable air purifier 50 is placed and used on the bottom surface lower than the user’s face, the portable air purifier 50 that stands vertically allows a greater amount of air purified in the portable air purifier 50 to reach the user’s face than the portable air purifier 50 that lies horizontally.

To this end, when purified air is discharged from the upper portion of the portable air purifier 50 in the state in which the portable air purifier 50 stands vertically, a greater amount of the air purified in the portable air purifier 50 reaches the user’s face.

In the embodiment, since the battery 560 is disposed in the lower portion of the portable air purifier 50, a flow path for the suction, purification and discharge of air is formed in a position higher than the position of the battery 560, in the portable air purifier 50. Accordingly, purified air is discharged from the upper portion of the portable air purifier 50, and a greater amount of the air purified in the portable air purifier 50 reaches the user’s face.

That is, in the structure where the battery 560 is disposed in the lower portion of the portable air purifier 50, the structural stability of the portable air purifier 50 can improve to reduce the risk of overturning of the portable air purifier 50 that stands vertically, and an efficient flow path can also be formed to enable a greater amount of air purified in the portable air purifier 50 to reach the user’s face.

Third, the structure, in which the battery 560 as a heavy object is disposed in the lower portion of the portable air purifier 50 such that components in relation to the suction, purification and discharge of air are disposed in a position higher than the position of the battery 560, may help to expand the range in which the portable air purifier 50 is installed.

In an example, when the portable air purifier 50 is used in the state of being held in a cup holder h in a vehicle, the area where air is suctioned and the area where purified air is discharged are disposed higher than the cup holder, such that the portable air purifier 50 is reliably held in vehicle while maintaining a high level of air purification performance. To this end, the up-to-down length of the second area B where the battery 560 is disposed is set to the depth of the cup holder or greater, for example.

In another example, if the lower area of the portable air purifier 50 is fixed by a tong type holder and the like, the portable air purifier 50 can be fixed stably while the portable air purifier 50’s areas where air is suctioned and discharged are not blocked.

That is, components such as a battery 560 that does not directly relate to an air flow for air purification are disposed in the lower portion of the portable air purifier 50, and the portable air purifier 50 is held and fixed through its lower portion, ensuring a high level of air purification performance and a reliable fixation of the portable air purifier 50.

### Disposition Structure of Fan Module and Filter Module

The portable air purifier 50 in the embodiment may include a fan module 540, 545 that suctions air from the rear of the portable air purifier 50 and discharges air through the front of the portable air purifier 50.

The fan module 540, 545 may be disposed between the fan cover 530 and the filter module 550. That is, the fan cover 530 may be disposed at the front of the fan module 540, 545, and the filter module 550 may be disposed at the rear of the fan module 540, 545.

While the fan module 540, 545 is accommodated in the accommodation space of the case 520, the fan module 540, 545 may be disposed in the first area A. Accordingly, the fan module 540, 545 may be disposed in a position that faces the rear surface of the upper cover part 531, out of the upper cover part 531 of the fan cover 530 and the lower cover part 535 of the fan cover 530.

In the embodiment, the portable air purifier 50 is provided with two fan modules 540, 545, for example. At this time, the portable air purifier 50 is provided with a first fan module 540 and a second fan module 545.

The first fan module 540 may be disposed between the discharge surface and the filter module 550, specifically, between the fan cover 530 and the filter module 550. At this time, the first fan module 540 may be disposed in parallel with the suction surface and the discharge surface. The second fan module 545 and the first fan module 540 may be disposed on the same surface. That is, the second fan module 545 may be disposed in parallel with the suction surface and the discharge surface, between the fan cover 530 and the filter module 550.

The positions of the first fan module 540 and the second fan module 545 are disposed not to overlap each other in the third direction. To this end, the first fan module 540 and the second fan module 545 may be disposed in the third direction, i.e., in the up-down direction. That is, the first fan module 540 and the second fan module 545 may be disposed on the same perpendicular line.

The first fan module 540 and the second fan module 545 may be disposed to face the air discharge part 532, 533 formed on the fan cover 530. Accordingly, air, suctioned into the first fan module 540 and the second fan module 545 through the rear surface panel 570, may pass through an upper air discharge part 532 and a lower air discharge part 533 respectively, and then be discharge forward through the front surface panel 510.

In the embodiment, the first fan module 540 and the second fan module 545 may have the same size and shape, for example. However, the first fan module 540 and the second fan module 545 may have a different size and shape.

The filter module 550 may be disposed between the suction surface and the fan module 540, 545. The filter module 550 includes a filter 559, and the filter 559 filters air suctioned through the suction surface.

The filter 559 may form a filter surface that forms a flat surface in a direction orthogonal to the directions in which the fan suctions and discharges air. That is, the filter 559 may form a filter surface parallel with the suction surface and the discharge surface. The suction surface, the filter surface of the filter 599 and the discharge surface may be disposed in a straight line.

Additionally, the filter 559 may form a filter surface parallel with the fan module 540, 545. The suction surface, the filter surface, the fan module 540, 545 and the discharge surface may be disposed in a straight line.

The positions of the first fan module 540 and the second fan module 545 in the first direction and the second direction may correspond to the area occupied by the filter surface. Further, the surface areas taken up by the first fan module 540 and the second fan module 545 may correspond to the surface area of the filter surface. For example, when viewed from the front, the first fan module 540 and the second fan module 545 may be disposed to overlap the filter surface.

Furthermore, the directions of the first fan module 540 and the second fan module 545’s suction of air may be the same as the directions of the suction surface and the discharge surface’s disposition. That is, the first fan module 540 and the second fan module 545 may suction air respectively in the first direction or the axial direction.

The surface area occupied by the fan module 540, 545 including the first fan module 540 and the second fan module 545 described above may correspond to the surface area of the suction surface and the surface area of the filter surface. Additionally, the surface area taken by the fan module 540, 545 may correspond to the surface area of the discharge surface. Under the assumption that the suction surface, the filter surface and the discharge surface have a corresponding surface area, the surface area occupied by the fan module 540, 545 may correspond to the surface area of each of the suction surface, filter surface and discharge surface.

Accordingly, air can be suctioned and discharged by the fan module 540, 545 through the entire suction surface and the entire discharge surface.

For example, air can be suctioned by the fan module 540, 545 through the suction surface that is ensured as much surface area as the fan module 540, 545. Air suctioned through the suction surface can be filtered by the filter surface that is ensured as much surface area as the suction surface and the fan module 540, 545. Additionally, air can be discharged by the fan module 540, 545 through the discharge surface that is ensured as much surface area as the fan module 540, 545.

That is, the suction surface and the discharge surface may ensure a passage having an optimal surface area required for the fan module 540, 545 to suction and discharge air. Additionally, the filter 559 may ensure a filter surface having an optimal surface area required to filter air suctioned through the suction surface. Thus, air may flow effectively, based on the operation of the fan module 540, 545.

In the embodiment, the suction surface, the filter surface, the fan module 540, 545 and the discharge surface are disposed in parallel. Additionally, the suction surface, the filter surface, the fan module 540, 545 and the discharge surface are disposed in the first direction, and air flows in the same direction. That is, air, flowing based on the operation of the fan module 540, 545, can flow, in the same straight line, in the same direction as the direction in which the suction surface, the filter surface, the fan module 540, 545 and the discharge surface are disposed.

As air flows in a straight line, resistance against the flow of the air decreases, and the air can flow more smoothly. Accordingly, a sufficient amount of air is suctioned, and in response, a sufficient amount of air is discharged by the fan module 540, 545, leading to improvement in the air purification performance of the portable air purifier 50.

### Structure of Fan Module

As described above, the portable air purifier 50 in the embodiment may include a plurality of fan modules 540, 545. In the embodiment, the portable air purifier 50 includes the first fan module 540 and the second fan module 545, and the first fan module 540 and the second fan module 545 have the same structure, for example. Herein, the structure of the first fan module 540 is described as an example.

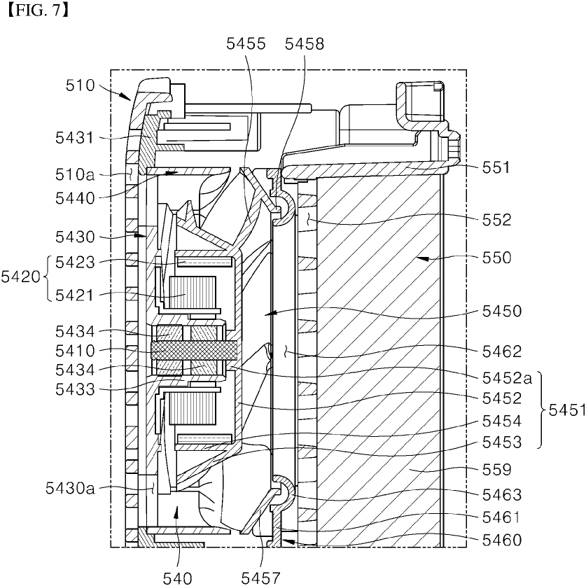

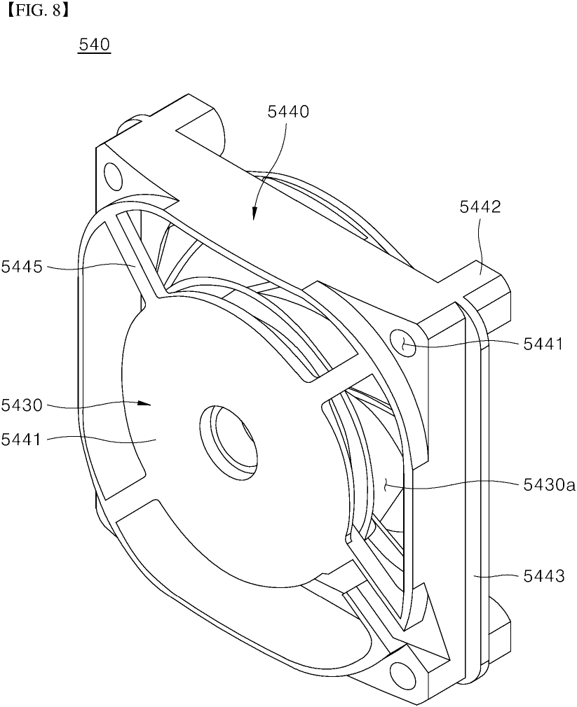

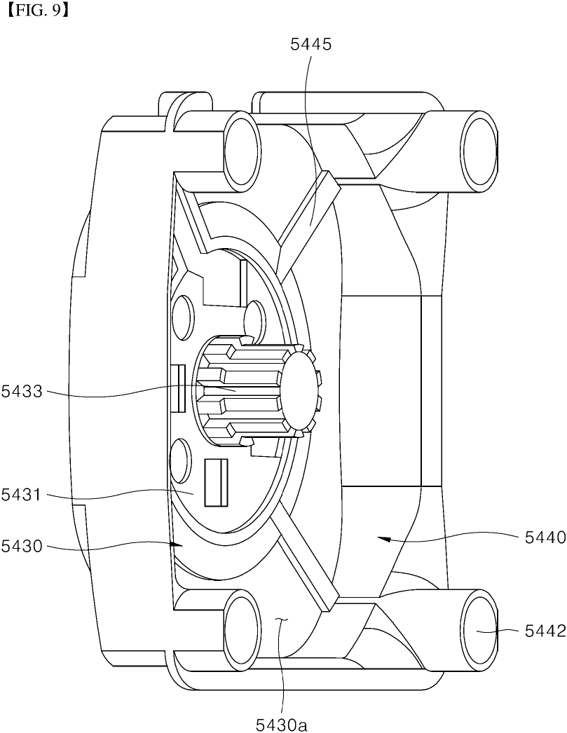

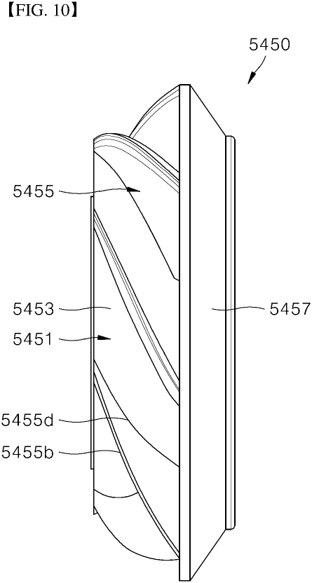

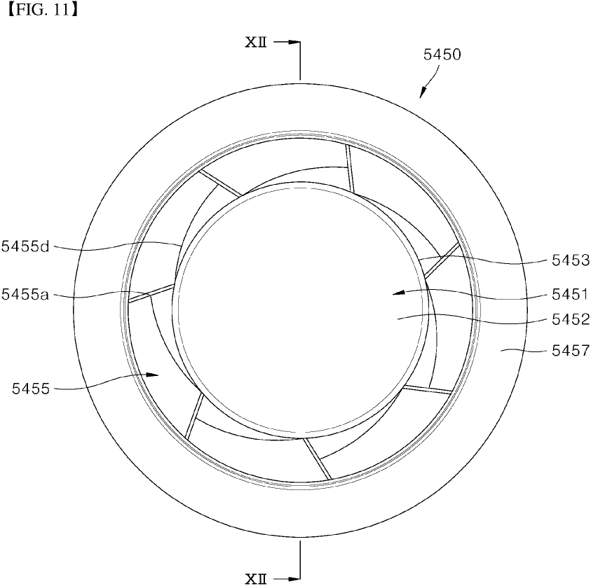

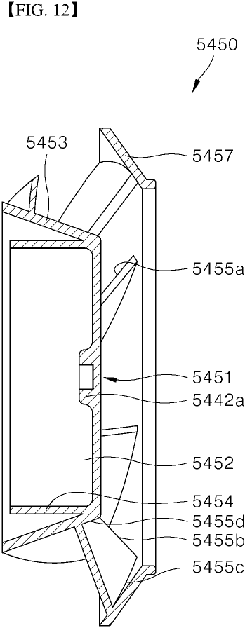

FIG. 7 is a cross-sectional view specifically showing the structure of portion “VII” in FIG. 4, FIG. 8 is a perspective view separately showing a fan module of one embodiment, and FIG. 9 is an perspective view separately showing a fan case in FIG. 8. FIG. 10 is a front view separately showing a fan in FIG. 8, FIG. 11 is a side view showing the fan in FIG. 10, and FIG. 12 is a cross-sectional view along line “X II - X II” in FIG. 11.

In FIG. 7, some components of the portable air purifier are omitted.

Referring to FIGS. 3, 4, 7 and 8, the first fan module 540 may include a shaft 5410, a motor 5420, a fan case 5430 and a fan 5440.

The shaft 5410 may extend in the first direction, i.e., the axial direction. One side of the shaft 5410 in the axial direction may be connected to the fan 5450. The other side of the shaft 5410 in the axial direction may be connected to the fan case 5430. Detailed description in relation to this is provided below.

The motor 5420 connects to the fan 5450 and applies a rotational force to the fan 5450. For example, the motor 5420 may be provided in the form of a BLDC motor in which a frequency can be adjusted. The motor 5420 may include a stator 5421 and a rotor 5423.

The stator 5421 may be disposed at the center side of the motor 5420 in the radial direction of the motor 5420, and the rotor 5423 may be disposed outside the stator 5421 in the radial direction of the stator 5421. That is, the motor 5420 in the embodiment may be provided in the form of an outer motor.

The stator 5421 may be fixed to the fan case 5430, 5440. The rotor 5423 may be fixed to the fan 5450. The rotor 5423 may rotate around the shaft 5410, outside the stator 5421, and the fan 5450 may rotate together with the rotor 5423 as the rotor 5423 rotates.

The fan case 5430, 5440 may support the stator 5421 and the shaft. The fan case 5430, 5440 may include a first support part 5430 and a second support part 5440, as illustrated in FIGS. 7 to 9.

The first support part 5430 may be disposed at the center side of the fan case 5430, 5440 in the radial direction of the fan case 5430, 5440. The first support part 5430 may include a support plate 5431 and a boss 5433.

The support plate 5431 may be formed into a circular plate. The support plate 5431 may form a flat surface that is parallel with at least any one of the suction surface, the filter surface and the discharge surface. The boss 5433 may protrude in the axial direction toward the fan 5450 from the support plate 5431. In the embodiment, the boss 5433 is disposed at the center of the support plate 5431 in the radial direction of the support plate 5431, for example.

The stator 5421 may be installed in the first support part 5430. The stator 5421 may be coupled to the boss 5433 while surrounding the boss 5433 from the outside in the radial direction. That is, the stator 5421 and the boss 5433 may be coupled in a way that the boss 5433 is fitted into the stator 5421 in the axial direction. The support plate 5431 may support the boss 5433 coupled to the stator 5421 at one side of the boss 5433 in the lateral direction, as described above.

Additionally, one side of the stator 5421 coupled to the boss 5433 in the axial direction of the stator 5421 may face the support plate 5431. While one side of the stator 5421 in the axial direction of the stator 5421 contacts the support plate 5431, the stator 5421 and the support plate 5431 may be coupled. Certainly, the stator 5421 may be installed in the first support part 5430 in a way that the stator 5421 is spaced from the support plate 5431.

Further, the boss 5433 may have a hollow hole, therein. The shaft 5410 may be inserted into the boss 5433 through the hollow hole. The shaft 5410 may pass through the boss 5433 in the axial direction and protrude from the boss 5433, and may be connected to a below-described hub 5451 of the fan 5450, outside the boss 5433.

A bearing 5435 may be inserted into the boss 5433 having the hollow hole. The shaft 5410 may be coupled to the bearing 5435, in the boss 5433. Accordingly, the shaft 5410 may be rotatably supported by the bearing 5435. In the embodiment, a pair of bearings 5435 is spaced a predetermined distance apart from each other in the axial direction, for example. The bearing 5435, disposed as described above, may help to install the shaft 5410 rotatably in the boss 5433 in a more reliable manner.

The second support part 5440 may support the first support part 5430, and couple the first fan module 540 to at least any one of the fan cover 530 and the filter module 550.

The second support part 5440 may be disposed outside the first support part 5430 in the radial direction of the first support part 5430. The second support part 5440 may support the first support part while surrounding the first support part 5430 from the outside in the radial direction.

The second support part 5440 may be formed into an approximate rectangle. For example, the length of the second support part 5440 in the second direction may be determined to correspond to the length of the filter module 550 in the second direction. Additionally, the length of the second support part 5440 in the third direction may be determined to correspond to half the length of the filter module 550 in the third direction. That is, if a pair of second support parts 5440 is disposed in the third direction, the exterior shapes of the pair of second support parts 5440 and the filter module 550 may be approximately aligned, when viewed from the front.

The second support part 5440 may have a hollow hole, therein. The hollow hole of the second support part 5440 may be formed in a way that the hollow hole penetrates the inside of the second support part 5440 in the axial direction. The hollow hole may have a radius greater than a radius of the support plate 5431. That is, a hollow hole bigger than the support plate 5431 is formed in the second support part 5440, and the support plate 5431 may be disposed in the second support part 5440.

Accordingly, the second support part 5440 may be spaced a predetermined distance apart from the first support part 5430, specifically, from the support plate 5431 in the centrifugal direction.

A fan outlet 5430a may be formed between the support plate 5431 and the second support part 5440 that are spaced as described above. The fan outlet 5430a may form a passage allowing air being introduced into the first fan module 540 to pass through the first fan module 540 and escape from the first fan module 540.

The fan case 5430, 5440 may further include a connection part 5445. The connection part 5445 may extend from the support plate 5431 in the centrifugal direction and may be connected to the second support part 5440. The connection part 5445 may connect the support plate 5431 and the second support part 5440 and help the second support part 5440 to support the support plate 5431.

In the embodiment, a plurality of connection parts 5445 may be disposed between the support plate 5431 and the second support part 5440. Additionally, each of the connection parts 5445 may have a width less than the length of the connection part 5445 in the radial direction. Each of the connection parts 5445, formed as described above, may be spaced at a predetermined interval along the circumferential direction of the support plate 5431.

Accordingly, while the fan outlet 5430a is formed between the support plate 5431 and the second support part 5440, the fan outlet 5430a may be respectively formed among the plurality of connection parts 5445.

Additionally, the connection part 5445 may provide a passage through which an electric wire, connected to the stator 5421 on the support plate 5431, passes. The electric wire connecting to the stator 5421 may be withdrawn toward the second support part 5440 side through the area where the connection part 5445 is disposed. At this time, the electric wire may pass through the fan outlet 5430a area in the state being covered by the connection part 5445, and connect the stator 5421 and the main PCB 595 (see FIG. 3). When viewed from the front, the electric wire that is withdrawn from the stator 5421 and passes through the fan outlet 5430a area is cover by the connection part 5445 and is not be seen.

The second support part 5440 may be provided with a side rib 5443. The side rib 5443 may be disposed at at least any one of both sides of the second support part 5440 in the second direction of the second support part 5440. The side rib 5443 may protrude from a lateral portion of the second support part 5440 in the second direction of the second support part 5440.

The length of the side rib 5443 in the second direction may be set to correspond to the length of the second support part 5440 in the second direction. Additionally, the length of the side rib 5443 in the first direction may be less than the length of the first support part 5430 in the first direction. That is, the side rib 5443 may have a thickness less than that of the first support part 5430. For example, the side rib 5443 may have a thickness that is one fourth or less of the thickness of the first support part 5430.

The side rib 5443 may be biased toward the front or the rear of the second support part 5440 while protruding from the second support part 5440. In the embodiment, the side rib 5443 is biased toward the rear of the second support part 5440, for example.

As the fan module 540, 545 is inserted into the case 520, the side rib 5443 may contact both lateral surfaces of the case 520, i.e., the inner surfaces of the first surface parts 521. Accordingly, predetermined space may be formed between a lateral surface of the second support part 5440 and the first surface part 521.

The formed space may be used as space for allowing an electric wire to pass. For example, an electric wire connecting to the sub PCB 595 disposed on the fan module 540, 545 may pass through the space and may be connected to the stator 5421 of the motor 5420.

Referring to FIGS. 7 and 10 to 12, the fan 5450 may include a hub 5451 and fan blade 5455.

The hub 5451 is disposed at the center of the fan 5450 in the radial direction of the fan 5450, and rotates together with the rotor 5423 and the shaft. The hub 5451 may include a first fan module 540, 545 and a skirt part 5433.

The first fan module 540, 545 may be formed into a circular plate parallel with the support plate 5431. The first fan modules 540, 545 may be disposed in parallel with the support plate 5431 with the boss 5433 between the first fan modules 540, 545.

The first fan module 540, 545 may be provided with a shaft coupling part 5452a. The shaft coupling part 5452a may be disposed at the center of the first fan module 540, 545 in the radial direction of the first fan module 540, 545. The shaft coupling part 5452a may protrude in the axial direction toward the boss 5433 from the first fan module 540, 545.

The shaft coupling part 5452a may be coupled to the end portion of the shaft 5410 in the axial direction of the shaft 5410. For example, the shaft coupling part 5452a may be coupled to the shaft 5410 in a way that the shaft 5410 is fitted into the shaft coupling part 5452a. The shaft 5410 may be fixed to the shaft coupling part 5452a or rotatably coupled to the shaft coupling part 5452a.

The skirt part 5453 may protrude toward the support plate 5431 from the edge of the hub plate part 5452. The skirt part 5453 may form a slant surface that inclines in the centrifugal direction as the skirt part 5452 becomes farther from the hub plate part 5452 in the axial direction. For example, the shape in which the hub plate part 5452 and the skirt part 5453 connect may be a truncated cone shape which has a hollow hole therein and one side of which is open. The skirt part 5433 may be disposed outside the stator 5421 in the radial direction of the stator 5421. That is, the stator 5421 may be disposed in space surrounded by the skirt part 5453 and the hub plate part 5452.

The fan blade 5455 may protrude from the hub 5451 in the centrifugal direction. The fan 5450 may be provided with a plurality of fan blades 5455, and the fan blades 5455 may be spaced a predetermined distance apart from one another along the circumference direction of the hub 5451.

Specifically, the fan blade 5455 may protrude from the skirt part 5453 in the centrifugal direction. At this time, the inside of the fan blade 5455 in the radial direction thereof may be connected to the skirt part 5453, and the outside of the fan blade 5455 in the radial direction thereof may be connected to a shroud 5457 that is described hererafter. That is, the skirt part 5453 is a portion of the hub 5451, which directly connects to the fan blade 5455 and directly contacts air passing through the first fan module 540. The skirt part 5453 may closely relate to a flow path of air passing through the first fan module 540.

The fan 5450 may further include a shroud 5457. The shroud 5457 may be spaced a predetermined distance apart from the hub 5451 in the radial direction, outside the hub 5451 in the radial direction thereof. The shroud 5457 may be spaced from the hub 5451 by a distance corresponding to the length of the fan blade 5455 in the radial direction of the fan blade 5455. Additionally, each of the fan blades 5455 may connect the hub 5451, specifically, the skirt part 5453, and the shroud 5457.

The shroud 5457 may form a slant surface that inclines in the centripetal direction as the shroud 5457 becomes farther from the fan case 5430, 5440 in the axial direction, i.e., toward the rear. For example, the shroud 5457 may form a slant surface that is approximately parallel with the skirt part 5453. In the embodiment, a gap between the skirt part 5453 and the shroud 5457 increases further toward the front, for example.

Each of the fan blades 5455, connecting the shroud 5457 and the skirt part 5433, may include a leading edge 5455a, a trailing edge 5455b, a shroud chord 5455c and a hub chord 5455d.

The leading edge 5455a may be disposed at the front end of the fan 5450 in a rotation direction and formed to be straight. The rotation direction is defined as a direction in which the fan 5450 rotates. The leading edge 5455a may be formed as a straight line that is disposed at the front end of the fan 5450 in the rotation direction of the fan 5450 and extends in the radial direction.

The trailing edge 5455b may be disposed at the rear end of the fan in the rotation direction and formed to be straight. The trailing edge 5455b may be formed as a straight line that extends in a direction between the axial direction and the radial direction.

The shroud chord 5455c may connect one end of the leading edge 5455a and one end of the trailing edge 5455b. The shroud chord 5455c may extend from the inner circumferential surface of the shroud 5457.

The hub chord 5455d may connect the other end of the leading edge 5455a and the other end of the trailing edge 5455b. The hub chord 5455d may extend from the outer circumferential surface of the hub 5451.

Additionally, one end of the leading edge 5455a and one end of the trailing edge 5455b may be connected to the inner circumferential surface of the shroud 5457. The other end of the leading edge 5455a and the other end of the trailing edge 5455b may be connected to the outer circumferential surface of the skirt part 5453.

One end of the leading edge 5455a may be disposed closer to the center of the hub plate part 5452 in the radial direction of the hub plate part 5452 than one end of the trailing edge 5455b. The other end of the leading edge 5455a may be disposed closer to the center of the hub plate part 5452 in the radial direction of the hub plate part 5452 than the other end of the trailing edge 5455b, since one end and the other end of the leading edge 5455a is disposed further forward than one end and the other end of the trailing edge 5455b in the rotation direction, and the radius of the skirt part 5453 decreases further toward the front in the rotation direction.

Additionally, the hub 5451 may include an inner projection part 5454. The inner projection part 5454 may protrude toward the support plate 5431 from the hub plate part 5452. In the embodiment, the inner projection part 5454 and the skirt part 5453 protrude from the same point on the hub plate part 5452, e. g. , from the edge of the hub plate part 5452, for example.

The inner projection part 5454 may be formed in a way that the inner projection part 5454 extends from the hub plate part 5452 in the axial direction. For example, the shape in which the hub plate part 5452 and the skirt part 5453 connect may be a cylinder shape which has a hollow hole therein and one side of which is open.

The inner projection part 5454 may be disposed between the skirt part 5453 and the stator 5421. That is, the stator 5421 may be disposed in space surrounded by the inner projection part 5454 and the hub plate part 5452.

The rotor 5423 may be disposed between the inner projection part 5454 and the stator 5421. The rotor 5423 may be fixed onto the inner circumferential surface of the inner projection part 5454. That is, the stator 5421 may be fixed to the fan case 5430, 5440, and the rotor 5423 may be fixed to the fan 5450. Accordingly, the fan 5450 may rotate together with the rotor 5423 as the rotor 5423 rotates.

In the embodiment, the fan blade 5455 may be connected to the skirt part 5453 of the hub 5451. To induce the flow of air flowing into the fan module 540, 545 in a direction between the axial direction and the radial direction, the skirt part 5453 forms a slant surface that inclines in a direction between the axial direction and the radial direction.

Since the skirt part 5453 is obliquely formed, it is difficult to fix the rotor 5423 to the inner circumferential surface of the skirt part 5453. For example, for the rotor 5423 to be fixed to the inner circumferential surface of the skirt part 5453, the rotor 5423 needs to be entirely formed into an approximate truncated cone having a hollow hole since the shape of the outer circumferential surface of the rotor 5423 needs to correspond to the shape of the inner circumferential surface of the skirt part 5453. However, the shape of the rotor 5423 may be inappropriate for the reliable driving of the motor 5420.

In consideration of the fact, in the embodiment, the inner projection part 5454 is provided between the skirt part 5453 and the stator 5421. The inner projection part 5454 may provide a fixation surface that allows the rotor 5423 to be fixed stably to the inside of the hub 5451 when the rotor 5423 is entirely formed into a cylinder having a hollow hole.

Additionally, the inner projection part 5454 may form a structure for improving the rigidity of the hub 5451, in the hub 5451. The inner projection part 5454 may help to improve the rigidity of the entire fan 5450 effectively while suppressing a significant increase in the weight of the entire fan 5450.

### Structure of Coupling Between Fan Module and Fan Cover

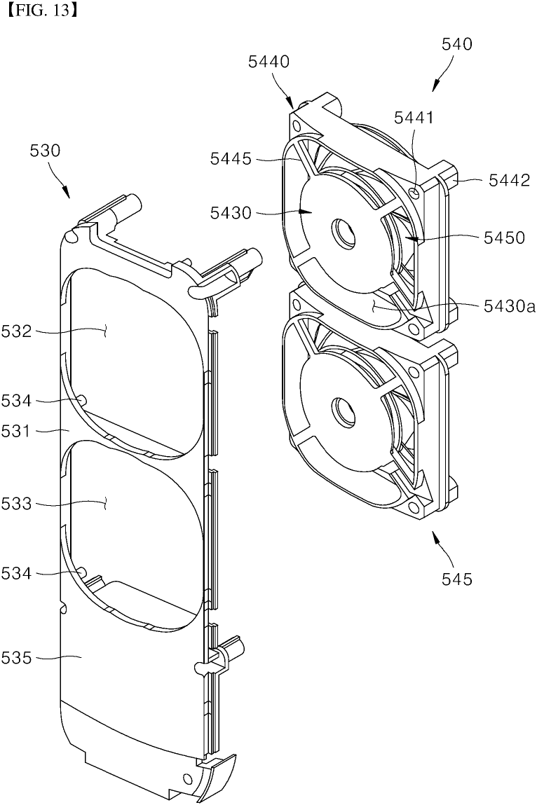

FIG. 13 is an exploded perspective view separately showing a fan cover and a fan module.

Referring to FIG. 13, the fan cover 530 may include an upper cover part 531 and a lower cover part 535.

The upper cover part 531 is disposed at the front of the fan module 540, 545. The upper cover part 531 may be provided with an air discharge part 532, 533. The air discharge part 532, 533 may be formed in a way that a portion of the upper cover part 531 penetrates or is cut. The air discharge part 532, 533 may form a passage that connects the front of the case 520, i.e., the discharge surface, and the fan 5450 of the fan module 540, 545, on the fan cover 530.

In the embodiment, the portable air purifier 50 is provided with two fan modules 540, 545, for example. That is, the first fan module 540 and the second fan module 545 are disposed vertically in the accommodation space of the case 520.

Accordingly, the fan cover 530 may also be provided with two air discharge parts 532, 533. That is, an upper air discharge part 532 and a lower air discharge part 533 may be disposed vertically at the upper cover part 531.

Air having passed through the first fan module 540 is discharged forward through the upper air discharge part 532, and air having passed through the second fan module 545 may be discharged forward through the lower air discharge part 533.

In another example, the portable air purifier may be provided with one fan assembly or three or more fan assemblies, and accordingly, the fan cover may be provided with one air discharge part or three or more air discharge parts.

Additionally, the upper cover part 531 may be provided with a first fastening projection 534. The first fastening projection 534 may protrude from the rear surface of the upper cover part 531 rearward. In response, the fan case 5430, 5440 may be provided with a fastening hole 5441. The fastening hole 5441 may be formed in a way that penetrates in the front-rear direction in the second support part 5440.

In an example, a total of four fastening holes 5441 may be provided, and each of the fastening holes 5441 may be disposed at each edge of the second support part 5440. The first fastening projection 534 may be disposed respectively in positions corresponding to the positions of the fastening holes 5441.

Each of the first fastening projections 534 may be inserted into the fastening hole 5441 and fitted into and coupled to the second support part 5440. As a result of the coupling between the first fastening projection 534 and the second support part 5440, the fan cover 530 and the fan module 540, 545 may be coupled at a plurality of points.

As the fan cover 530 and the fan module 540, 545 are coupled, the fan module 540, 545 may be fixed to the rear of the fan cover 530. At this time, the fan module 540, 545 may be fixed in the position where the fan outlet 5430a formed at the front of the fan module 540, 545 overlaps the air discharge part 532, 533 formed at the fan cover 530 in the first direction. Thus, a straight line passage may be formed to allow air discharged from the fan module 540, 545 to pass through the fan cover 530.

### Structure of Fan Base

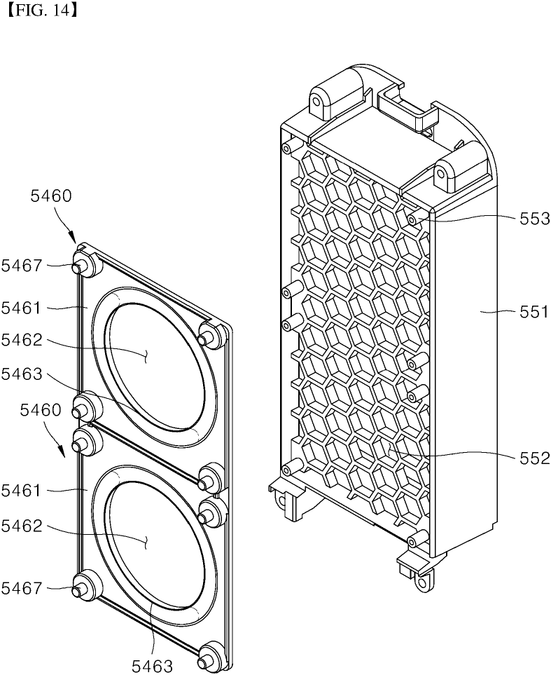

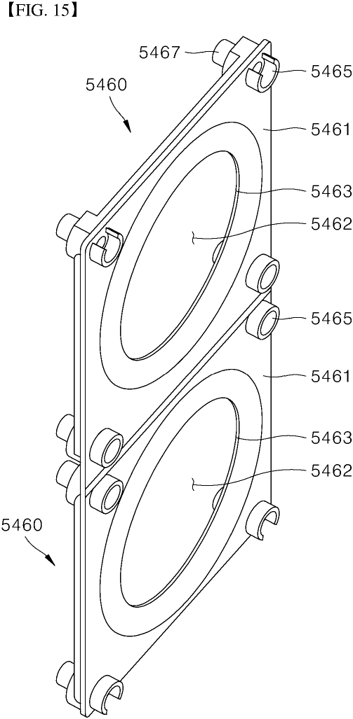

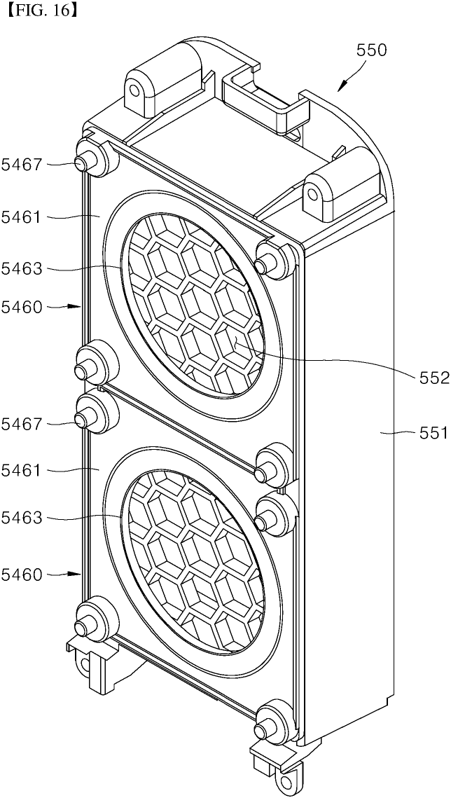

FIG. 14 is an exploded perspective view separately showing a fan module, a fan base and a filter, FIG. 15 is a rear perspective view showing the rear surface of a fan base, and FIG. 16 is a perspective view showing a coupling state between the fan base and the filter.

Referring to FIGS. 7 and 13 to 16, the portable air purifier 50 according to the present disclosure may further include a fan base 5460.

The fan base 5460 may be disposed between the filter module 550 and the fan module 540, 545. The fan base 5460 may be formed into a shape corresponding to the shape of the filter surface. For example, the fan base 5460 may be formed into a shape of the filter 559 viewed from the front, i.e., a rectangular shape. The fan base 5460 may include a base plate 5461, and a bell mouth 5463.

In this embodiment, two fan bases 5460 disposed in the third direction, i.e., the up-down direction, are disposed between the filter module 550 and the fan module 540, 545, for example. At this time, one fan base 5460 disposed in the upper portion is disposed between the first fan module 540 and the filter module 550, and the other fan base 5460 disposed in the lower portion is disposed between the second fan module 545 and the filter module 550.

When the fan base 5460 is provided separately depending on the number of the fan modules, the fan base 5460 may be provided in response to the number of the fan modules even if the number of the fan modules varies. That is, when one fan module is provided, one fan base 5460 is applied, and when two or more fan modules are provided, the same number of the fan bases 5460 as the number of the fan modules may be stacked in the up-down direction. Thus, the fan base 5460 is provided regardless of the number of the fan modules, ensuring ease of management of components.

Despite the fact, the fan base 5460 may be provided in a way that a single fan base 5460 includes a plurality of fan inlets 5462.

The base plate 5461 may be disposed between the filter module 550 and the fan module 540, 545. The length of the base plate 5461 in the first direction may be much less than that of the filter module 550 and the fan module 540, 545. For example, the base plate 5461 may be formed into a rectangular plate.

The base plate 5461 may have a fan inlet 5462. The fan inlet 5462 may be formed in a way that fan inlet 5462 penetrates on the base plate 5461 in the first direction. The fan inlet 5462 may be disposed approximately in the position where the fan inlet 5462 overlaps the air discharge part 532, 533 (see FIG. 13) of the fan cover 530 and the fan outlet 5430a of the fan module 540, 545 in the first direction. The fan inlet 5462 formed as described above may form a passage that connects the filter 559 and the fan module 540, 545, at the fan base 5460.

The bell mouth 5463 may protrude from the base plate 5461. The bell mouth 5463 may protrude from the base plate 5461 to the fan module 540, 545, in the axial direction.

In the embodiment, the fan inlet 5462 has the same shape as the shroud 5457, i.e., a circular shape, for example. Additionally, the radius of the fan inlet 5462 may be set similarly to the radius of a portion of the shroud 5457, which is adjacent to the fan inlet 5462.

The bell mouth 5463 may be formed in a way that the bell mouth 5463 surrounds the outer circumferential surface of the fan inlet 5462 formed as described above. In other words, the fan inlet 5462 may be formed in a way that the fan inlet 5462 penetrates at the inside of the bell mouth 5463 in the radial direction of the bell mouth 5463.

The bell mouth 5463 may protrude toward the fan module 540, 545 from the fan inlet 5462 in the first direction. At this time, at least a portion of the bell mouth 5463 may be inserted into the shroud 5457 in the radial direction of the shroud 5457. The bell mouth 5463 guides a suction flow at the entrance of the fan module 540, 545, and help to improve the suction and discharge performance of the fan module 540, 545.

The fan base 5460 may be coupled to the fan base 5460. To this end, any one of the fan base 5460 and the filter module 550 may have a fastening boss 5433, and any one of the fan base 5460 and the filter module 550 may have a second fastening projection 553. In the embodiment, the fan base 5460 has the fastening boss 5433, and the filter module 550 has the second fastening projection 553, for example.

The fastening boss 5433 may protrude from the base plate 5461 to the filter module 550 in the first direction. The fastening boss 5433 may have a hollow hole. The second fastening projection 553 may protrude from the filter module 550, specifically, the front surface of the filter case 551, toward the fan base 5460 in the first direction. The second fastening projection 553 may be fitted into and coupled to the fastening boss 5433 in a way that the second fastening projection 553 is inserted into the hollow hole of the fastening boss 5433.

In an example, a total of four fastening bosses 5433 are provided, and each of the fastening bosses 5433 may be disposed at each edge of the first support part 5430. The second fastening projection 553 may be disposed respectively in positions corresponding to the positions of the fastening bosses 5433.

Based on the coupling between the second fastening projection 553 and the fastening boss 5433, the fan base 5460 and the filter module 550 may be coupled at a plurality of points. As the fan base 5460 is coupled to the filter module 550 as described above, the fan base 5460 may be fixed to the front of the filter module 550.

Additionally, the fan base 5460 may be coupled to the fan module 540, 545. To this end, any one of the fan base 5460 and the fan module 540, 545 is provided with a third fastening projection 5467, and the other may be provided with a projection boss 5442. In the embodiment, the fan base 5460 is provided with the third fastening projection 5467, and the fan module 540, 545 is provided with the projection boss 5442, for example.

The projection boss 5442 may protrude from the second support part 5440 toward the fan base 5460 in the first direction. The projection boss 5442 may have a hollow hole. The third fastening projection 5467 may protrude from the front surface of the base plate 5461 toward the front. The third fastening projection 5467 may be fitted into and coupled to the fastening boss 5433 in a way that the third fastening boss 5467 is inserted into the hollow hole of the projection boss 5442.

As the projection boss 5442 and the third fastening projection 5467 are coupled, the fan base 5460 and the fan module 540, 545 may be coupled such that the second support part 5440 is spaced a predetermined distance apart from the base plate 5461. At this time, the predetermined distance is set to the length of a portion of the fan 5450 in the axial direction, protruding outward in the radial direction of the second support part 5440, e. g. , the length of the shroud 5457 in the first direction, or greater.

Further, a total of four projection bosses 5442 are provided, and each of the projection bosses 5442 may be disposed at each edge of the second support part 5440. The third fastening projection 5467 may be disposed respectively in positions corresponding to the positions of the projection bosses 5442.

A gap between the portions where each of the projection bosses 5442 and each of the third fastening projections 5467 are coupled may be open in the radial direction. Additionally, a portion of the fan 5450, specifically, a portion of the shroud 5457, may protrude outward in the radial direction of the second support part 5440 through the open portions.

The fan base 5460 described above may serve as a coupling medium for coupling between the fan module 540, 545 and the filter module 550, and guide a suction flow at the entrance of the fan module 540, 545 to improve the suction and discharge performance of the fan module 540, 545.

### Aspect of Air Flow of Portable Air Purifier

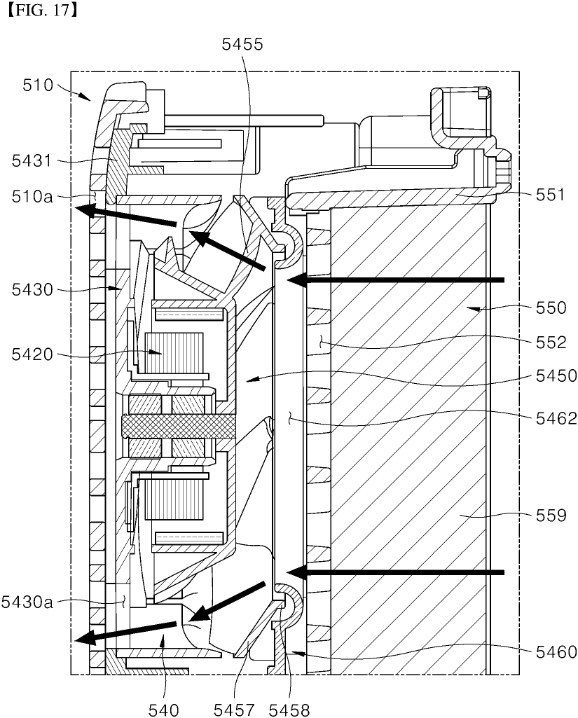

FIG. 17 is a view showing an aspect of the air flow of the portable air purifier of one embodiment.

In FIG. 17, some components are omitted from the portable air purifier.

Hereinafter, an aspect of the air flow of the portable air purifier in the embodiment is described with reference to FIGS. 4 and 17.

Referring to FIGS. 4 and 17, as the fan module 540, 545 operates, air behind the portable air purifier 50 flows into the portable air purifier 50. At this time, the air behind the portable air purifier 50 may pass through the suction surface through the first suction inlet 570a formed on the rear surface cover 580.

The air having passed through the suction surface and being introduced into the portable air purifier 50 passes through the filter 559, and while the air passes through the filter 559, the filter 60 can filter physical particles such as dust/fine dust/ultra fine dust and the like, chemical substances such as odorant particles/harmful gases and the like, and microorganisms such as germs/viruses and the like, that are included in the air.

At this time, the air may be suctioned into the filter 559 through the suction surface that has as much surface area as the filter surface. Additionally, the air suctioned through the suction surface may be filtered through the filter surface that has as much surface area as the fan module 540, 545.

That is, air may be suctioned and filtered effectively through the suction surface and the filter surface that have sufficient surface areas corresponding to the surface area of the fan module 540, 545. Additionally, since the suction surface, the filter surface and the fan module 540, 545 are disposed in a straight line, air may be suctioned and filtered effectively while flow loss is minimized.

The air having passed through the filter 559, i.e., purified air, may flow into the fan module 540, 545 through the fan inlet 5462. The flow of the air passing through the fan inlet 5462 may be guided by the bell mouth 5463, and accordingly, a smooth inflow of air to the fan module 540, 545 may be induced effectively.

The air being introduced into the fan module 540, 545 may be discharged in a mixed flow direction while being discharged from the front of the fan module 540, 545 through the fan outlet 5430a. The mixed flow direction may be defined as a front-side diagonal direction.

The air, discharged from the front of the fan module 540, 545, i.e., purified air, passes through the fan cover 530, and is discharged from the front of the portable air purifier 50. At this time, the purified air may pass through the discharge surface through the discharge outlet 510a formed on the front cover 510.

The purified air may be discharged through the discharge surface that has as much surface area as the suction surface, the filter surface and the fan module 540, 545. That is, the purified air may be discharged effectively through the discharge surface that has a sufficient surface area corresponding to the surface area of the suction surface, the surface area of the filter surface and the surface area of the fan module 540, 545. Further, since the suction surface, the filter surface, the fan module 540, 545 and the discharge surface are disposed in a straight line, air may be suctioned and filtered, and purified air may be discharged, effectively, while flow loss is minimized.

### Effect of Portable Air Purifier with Mixed Flow Fan-Type Fan

The portable air purifier 50 in the embodiment include a mixed flow fan type- fan 5450. The portable air purifier 50 may produce the following effects.

First, since the fan module 540, 545 includes a mixed flow fan-type fan 5450, the fan module 540, 545 may ensure improvement in air purification performance, compared to a fan module including an axial flow fan-type fan.

The axial flow fan allows air to be suctioned and discharged in a straight line. The axial flow fan may have a small thickness, and can be applied to a small-sized air purifier.

However, the performance of the axial flow fan significantly deteriorates at fixed pressure. For example, if the density or the thickness of the filter 559 increases to enhance filtering performance, the suction and discharge performance of the axial flow fan may significantly deteriorate. Accordingly, it is difficult to apply an axial flow fan to a portable air purifier with a high performance filter.

The mixed flow fan is somewhere between an axial flow fan and a centrifugal fan, and ensures more excellent performance at fixed pressure than the axial flow fan on condition that the mixed flow fan has the same size as the axial flow fan. However, the length of a mixed flow fan in the axial direction is greater than that of an axial flow fan on condition that the mixed flow fan has the same size as the axial flow fan.

However, the axial flow fan is inappropriate to send high-pressure high-speed air. Accordingly, a portable air purifier to which an axial flow fan is applied needs to further include a structure such as a guide vane. For example, a guide vane may be formed in the air discharge part 532, 533 of the fan cover 530. The guide vane may be a cause for an increase in the length of the fan cover 530 in the first direction, i.e., the thickness of the fan cover 530.

An increase in the thickness of the fan cover 530, caused by the guide vane, results in a decrease in the length of the axial flow fan in the first direction due to the limited space in the portable air purifier, and a deterioration in the suction and discharge performance of the axial flow fan.

Unlike an axial flow fan, a mixed flow fan is appropriate to send high-pressure high-speed air. That is, without a structure such as a guide vane, the mixed flow fan may send air much farther than the axial flow fan.

For this reason, in the embodiment, the fan cover 530 excludes a structure such as a guide vane. Accordingly, the thickness of the fan cover 530 decreases, and the fan module 540, 545 is small enough to be inserted into the air discharge part 532, 533. For example, the length of the fan module 540, 545 in the first direction may be determined to the extent that the front surface of the fan module 540, 545 and the front surface of the fan cover 530 constitute the same surface. That is, the length of the fan module 540, 545 in the first direction may extend by a length occupied by a guide vane.

As the size of the fan module 540, 545 increases, the suction and discharge performance of the fan module 540, 545 improves, enabling the portable air purifier 50 in the embodiment to ensure improvement in air purification performance.

Additionally, in the structure of the fan module 540, 545, the fan case 5430, 5440 does not surround the fan 5450 from the outside in the radial direction. That is, the fan 5450 may be formed to protrude further in the centrifugal direction than the inner circumferential surface of the second support part 5440. Accordingly, at least a portion of the fan 5450 may protrude to a gap between the second support part 5440 and the base plate 5461.

Since the fan 5450 protrudes further in the centrifugal direction than the inner circumferential surface of the second support part 5440 as described above, the size of the fan 5450 may increase.

As the size of the fan module 540, 545 increases as described above, the suction and discharge performance of the fan module 545, 545 improves, enabling the portable air purifier 50 in the embodiment to ensure improvement in air purification performance.

Second, since the fan module 540, 545 includes a mixed flow fan-type fan 5450, the range in which the portable air purifier 50 discharges air may expand.

A mixed flow fan can discharge air in the mixed flow direction, and accordingly, purified air discharged through the discharge surface may be discharged in the mixed flow direction, i.e., a direction between the front and the centrifugal direction.

When it comes to a small-sized portable air purifier 50, if purified air is discharged toward the front only in a straight line, the range of the discharge of the purified air is limited to a range corresponding to the discharge surface.

If the purified air is discharged within a range corresponding to the discharge surface, even considering the properties of the small-sized portable air purifier 50, limitations are imposed on the use of the portable air purifier 50.

For example, the user has to keep holding up the portable air purifier 50 or has to accurately adjust the position of the portable air purifier 50 such that the discharge outlet 510a faces the user’s face, causing inconvenience to the user.

The portable air purifier 50 in the embodiment may discharge high-pressure high-speed air in a direction between the front and the centrifugal direction. Accordingly, purified air may spread to a large area as well as reaching a far corner, enabling the portable air purifier 50 to ensure improvement in air purification performance.

Third, each fan module 540, 545 includes the mixed flow fan-type fan 5450, and a plurality of fan modules 540, 545 are stacked, allowing purified air to be discharged far away.

As described above, a mixed flow fan can discharge air in the mixed flow direction. At this time, a collision between air discharged from the first fan module 540 and air discharged from the second fan module 545 may occur, in the portion where the fan modules 540, 545 are adjacent to each other.

For example, air may be discharged obliquely downward at the lower side of the first fan module 540 adjacent to the second fan module 545, and air may be discharged obliquely upward at the upper side of the second fan module 545 adjacent to the first fan module 540.

At this time, a portion of the air discharged from the first fan module 540 and a portion of the air discharged from the second fan module 545 may collide with each other. Thus, their radiuswise speed vector decreases, and their frontwise speed vector may increase.

A decrease in the radiuswise speed vector and an increase in the frontwise speed vector denote the direction of speed vector of air discharged from the portable air purifier 50 changes to a direction close to the front.

As a result, the portable air purifier 50 discharges air mainly toward the front, and allows the air to reach a far corner, ensuring improvement in air purification performance.

### Second Embodiment of Portable Air Purifier

### Entire Structure of Fan

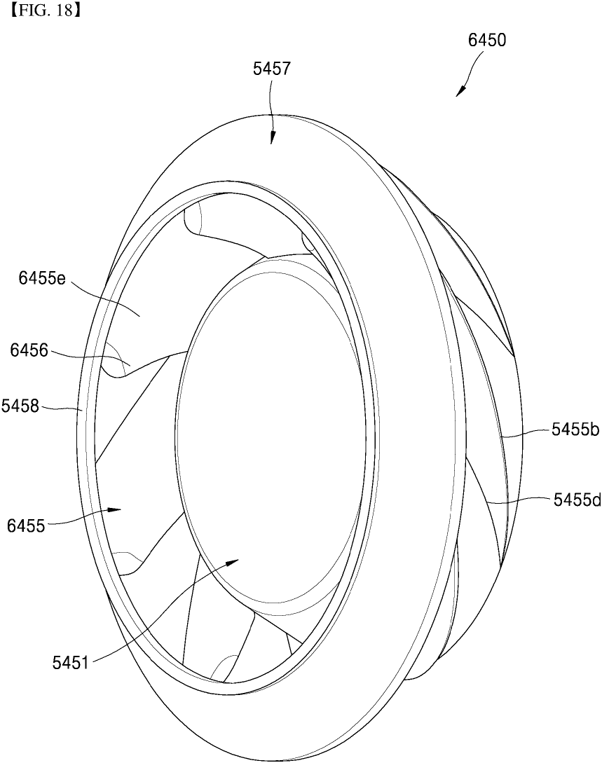

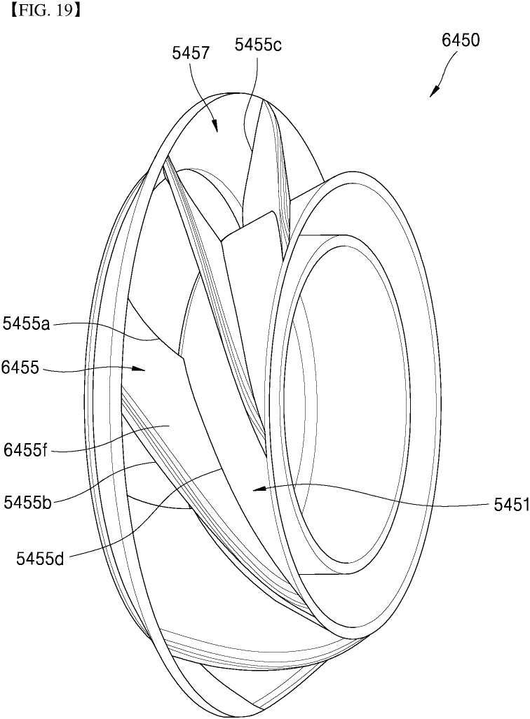

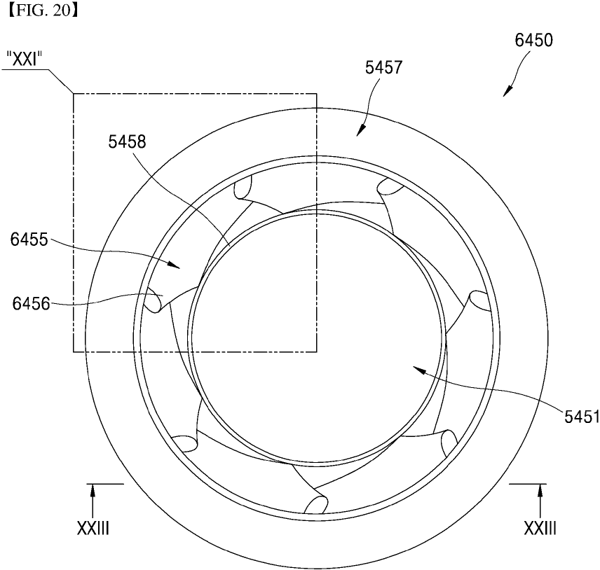

FIG. 18 is a front perspective view showing a front surface side of a fan provided in a portable air purifier of another embodiment, FIG. 19 is a rear perspective view showing a rear surface side of the fan in FIG. 18, and FIG. 20 is a front view showing the front surface side of the fan in FIG. 18.

Referring to FIGS. 18 to 20, the portable air purifier of another embodiment and the portable air purifier of the above-described embodiment have different structures for a fan 6450.

The fan 6450 in the embodiment may include a plurality of fan blades 5455. Each of the fan blades 5455 may include a leading edge 5455a, a trailing edge 5455b, a shroud chord 5455c, and a hub chord 5455d.

The leading edge 5455a may be disposed at a front end of the fan in a rotation direction and formed to be straight. The leading edge 5455a may be formed as a straight line that is disposed at the front end of the fan 5450 in the rotation direction of the fan 5450 and extends in a radial direction.

The trailing edge 5455b may be disposed at a rear end of the fan in the rotation direction and formed to be straight. The trailing edge 5455b may be formed as a straight line that extends in a direction between an axial direction and the radial direction.

The shroud chord 5455c may connect one end of the leading edge 5455a and one end of the trailing edge 5455b. The shroud chord 5455c may extend from an inner circumferential surface of a shroud 5457.

The hub chord 5455d may connect the other end of the leading edge 5455a and the other end of the trailing edge 5455b. The hub chord 5455d may extend from an outer circumferential surface of a hub 5451.

Additionally, one end of the leading edge 5455a and one end of the trailing edge 5455b may be connected to the inner circumferential surface of the shroud 5457. Additionally, the other end of the leading edge 5455a and the other end of the trailing edge 5455b may be connected to an outer circumferential surface of a skirt part 5453.

The fan blade 6455 may include a fan blade front surface 6455e and a fan blade rear surface 6455f which connect the leading edge 5455a and the trailing edge 5455b. Both the fan blade front surface 6455e and the fan blade rear surface 6455f correspond to surfaces formed into shapes surrounded by the leading edge 5455a, the trailing edge 5455b, the shroud chord 5455c, and hub chord 5455d. Among them, the fan blade front surface 6455e is a surface disposed further forward than the fan blade rear surface 6455f in the rotation direction and is disposed at one side in the axial direction, and the fan blade rear surface 6455f corresponds to an opposite surface thereof.

Additionally, the fan 6450 may further include a front end projection part 6456. The front end projection part 6456 may protrude forward from a front end of the fan blade 6455 in the rotation direction.

### Structure of Front End Projection Part

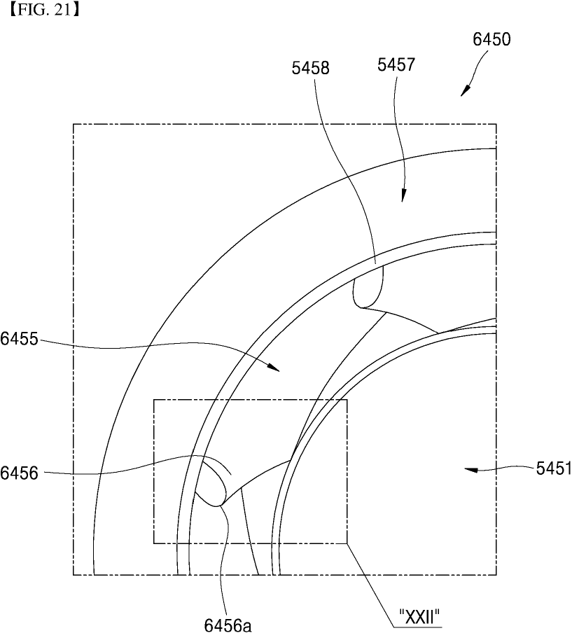

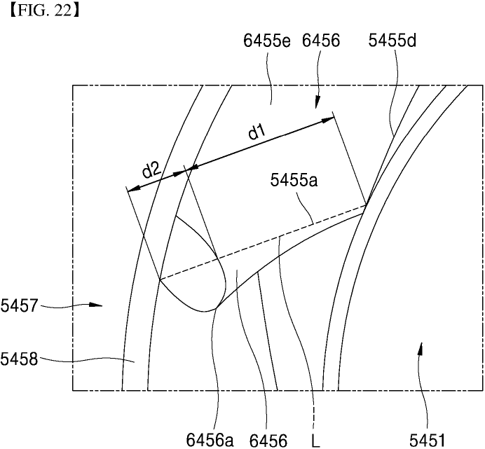

FIG. 21 is an enlarged view showing portion “XXI” in FIG. 20, and FIG. 22 is an enlarged view showing portion “XXII” in FIG. 21.

Referring to FIGS. 19, 21, and 22, the front end projection part 6456 may be formed in a way that at least a part of the front end projection part 6456 protrudes further forward than a front end reference line L in the rotation direction.

The front end reference line L is defined as a straight line connecting a connection point of the front end of the fan blade 6455 in the rotation direction and the hub 5451 and a connection point of the front end of the fan blade 6455 in the rotation direction and the shroud. In other words, the front end reference line L may also be defined as a straight line that is substantially the same as a straight line formed by the leading edge 5455a.

When the front end reference line L is substantially the same as the straight line formed by the leading edge 5455a, the front end projection part 6456 may be formed to protrude from the leading edge 5455a.

The front end projection part 6456 may protrude forward from the leading edge 5455a in the rotation direction. The front end projection part 6456 may protrude further forward than the shroud chord 5455c, specifically, a connection point of the leading edge 5455a and the shroud chord 5455c, in the rotation direction.

In the embodiment, the shroud chord 5455c may be obliquely formed with a predetermined slant angle in a way that the shroud chord 5455c is disposed at one side in the axial direction from the trailing edge 5455b side toward the leading edge 5455a side, i.e., toward the frond side in the rotation direction.

Additionally, the front end projection part 6456 may be formed in a way that the front end projection part 6456 forms a slant angle parallel with the slant angle of the shroud chord 5455c and protrudes forward from the leading edge 5455a in the rotation direction. That is, the front end projection part 6456 may constitute the same surface along with the shroud chord 5455c and the fan blade front surface 6455e and protrude forward from the leading edge 5455a in the rotation direction.

The front end projection part 6456 may be disposed in a way that a foremost side projection point 6456a of the front end projection part 6456 is disposed closer to the shroud 5457 than the hub 5451. That is, a position of the front end projection part 6456 in the radial direction may be biased toward the shroud 5457 side.

It is preferable that a ratio of a distance d1 between the foremost side projection point 6456a of the front end projection part 6456 and the hub 5451 to a distance d2 between the foremost side projection point 6456a of the front end projection part 6456 and the shroud 5457 may be set to be in the range of 3:1 to 5:1. It is more preferable that the ratio of the distance d1 between the foremost side projection point 6456a of the front end projection part 6456 and the hub 5451 to the distance d2 between the foremost side projection point 6456a of the front end projection part 6456 and the shroud 5457 may be set to 4:1.

For example, when the distance d1 between the foremost side projection point 6456a of the front end projection part 6456 and the hub 5451 is 8 mm, a shape of the front end projection part 6456 may be determined such that the distance d2 between the foremost side projection point 6456a of the front end projection part 6456 and the shroud 5457 is 2 mm.

Additionally, the front end projection part 6456 may be obliquely formed in a way that the front end projection part 6456 protrudes further toward one side in the axial direction as the front end projection part 6456 becomes to be close to the foremost side projection point 6456a of the front end projection part 6456 from the other end side of the leading edge 5455a, i.e., in a centrifugal direction from the other end side of the leading edge 5455a adjacent to the hub 5451 toward the foremost side projection point 6456a of the front end projection part 6456.

Accordingly, a shape of the fan blade 6455 in a section from the other end of the leading edge 5455a and the foremost side projection point 6456a of the front end projection part 6456 may be formed in a way that a length of the fan blade 6455 in the rotation direction gradually increases in the centrifugal direction.

Additionally, in the section between the foremost side projection point 6456a of the front end projection part 6456 and one end of the leading edge 5455a, a projection length of the front end projection part 6456 may gradually decrease in the centrifugal direction. In other words, in the section between the foremost side projection point 6456a of the front end projection part 6456 and one end of the leading edge 5455a, the projection length of the front end projection part 6456 may gradually increase from one end of the leading edge 5455a toward the foremost side projection point 6456a of the front end projection part 6456 in a centripetal direction.

That is, the projection length of the front end projection part 6456 may gradually increase from the other end of the leading edge 5455a toward the foremost side projection point 6456a of the front end projection part 6456 in the centrifugal direction, the foremost side projection point 6456a of the front end projection part 6456 may be a most protruding portion of the front end projection part 6456, and the projection length of the front end projection part 6456 may gradually decrease from the foremost side projection point 6456a of the front end projection part 6456 toward one end of the leading edge 5455a in the centrifugal direction.

Accordingly, the shape of the entire fan blade 6455 is formed so that a width of the fan blade 6455 in the rotation direction gradually increases to a predetermined point (the foremost side projection point of the front end projection part) adjacent to the shroud 5457. That is, the fan blade 6455 is provided in a way that an area of a portion of the fan blade 6455 adjacent to the shroud 5457 increases relative to a portion adjacent to the hub 5451 in the fan blade 6455.

A flow of air passing through the fan 6450 while the air is suctioned and discharged by operation of the fan 6450 will be described. A speed of air passing through a portion adjacent to the shroud 5457 is greater than a speed of air passing through a portion adjacent to the hub 5451. That is, a speed of air passing through an outer portion of the fan blade 6455 in the radial direction is greater than a speed of air passing through a central portion of the fan 6450 in the radial direction. This may be understood as a feature of a mixed flow fan which suctions air in an axial direction and discharges the air in a direction between the axial direction and a centrifugal direction.

In consideration of this feature, it may be understood that a larger amount of air may be blown from a region adjacent to the shroud 5457 than a region adjacent to the hub 5451 by the fan blade front surface 6455e which is a surface corresponding to a pressure surface.

In consideration of the above fact in the embodiment, the shape of the fan blade 6455 is determined in a way that an area of the region adjacent to the shroud 5457 is greater than an area of the region adjacent to the hub 5451 in the fan blade front surface 6455e. To this end, the front end projection part 6456 is formed on the front end of the fan blade 6455 in the rotation direction.

As the fan blade 6455 is formed in the above-described shape, the fan blade 6455 may secure a larger contact area with air in a region which blows a larger amount of air than another region.

As a result, when a flow rate is the same, a flow rate blown by the fan blade 6455 per unit area of the fan blade 6455 may decrease. That is, as an area of a region which may blow a larger amount of air than another region increases, a pressure received by the fan blade 6455 per unit area while blowing air may decrease.

Additionally, due to a projection structure formed by the front end projection part 6456 in a way that a part of the fan blade 6455 protrudes, an increase in rigidity of the fan blade 6455 can be expected.

Additionally, in the embodiment, the other end of the leading edge 5455a and the foremost side projection point 6456a of the front end projection part 6456 are connected roundly in the front end projection part 6456, for example. At this time, the front end projection part 6456 may be formed in a curved shape that is convex toward the trailing edge 5455b, i.e., to the rear side in the rotation direction.

As the front end projection part 6456 is formed in the curved shape described above, structural stability of a front end portion of the fan blade 6455 in the rotation direction can be improved, and thus a more increase in rigidity of the fan blade 6455 can be expected.

That is, due to the structure of the fan 6450 in the embodiment as an example, a pressure received by the fan blade 6455 per unit area decreases, and rigidity of the fan blade 6455 itself increases.

### Shape of Cross Section of Fan Blade

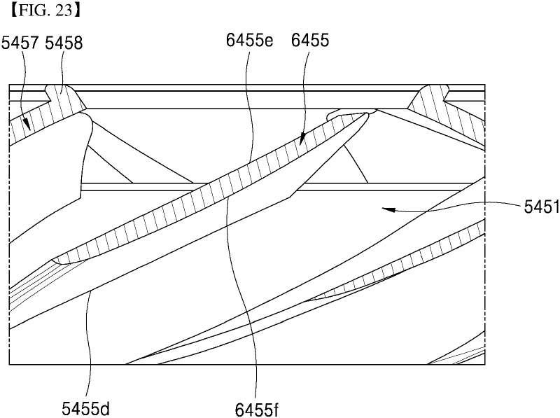

FIG. 23 is a cross-sectional view along line “XXIII-XXIII” in FIG. 20.

Referring to FIGS. 18 and 23, the fan blade 6455 may include the fan blade front surface 6455e disposed at one side in the axial direction and the fan blade rear surface 6455f disposed at the other side in the axial direction based on the leading edge 5455a and the trailing edge 5455b.

The fan blade front surface 6455e corresponds to a pressure surface disposed at a side through which air being introduced into the fan 6450 is blown to a discharge outlet side. Additionally, the fan blade rear surface 6455f corresponds to a negative pressure surface disposed at a side at which air flown into the fan 6450 is suctioned.

In the embodiment, the fan blade front surface 6455e and the fan blade rear surface 6455f may be formed in shapes different from each other.

Specifically, the fan blade rear surface 6455f may be formed in the shape connecting the leading edge 5455a and the trailing edge 5455b straightly. That is, the fan blade rear surface 6455f may be formed in a flat shape.

Additionally, the fan blade front surface 6455e may roundly connect the leading edge 5455a and the trailing edge 5455b. Specifically, the fan blade front surface 6455e may be formed in the shape connecting the leading edge 5455a and the trailing edge 5455b using a curved surface that is convex toward one side in the axial direction. A camber may be formed on the fan blade front surface 6455e formed as described above at one side of the fan blade 6455 in the axial direction.

As the shape of the fan blade 6455 is designed in a way that the camber is formed on the fan blade front surface 6455e as described above, the performance of the fan 6450 at fixed pressure can be further improved. Accordingly, the discharge performance of the fan 6450 can be further improved, and noise can also be effectively reduced compared to a fan blowing the same flow rate.

Additionally, as the camber is formed on only the fan blade front surface 6455e, and the fan blade rear surface 6455f is formed in the flat shape, there is an advantage in molding the fan 6450 using a mold. Detailed description in relation to this is provided below.

### Relationship Between Shape of Fan Blade and Mold

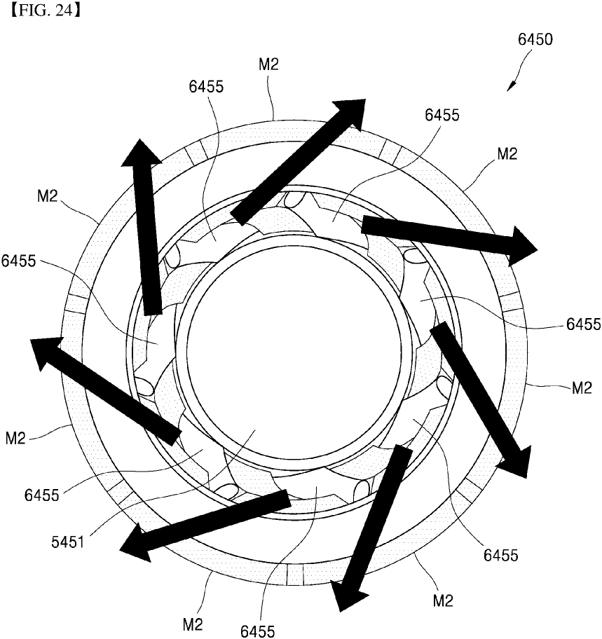

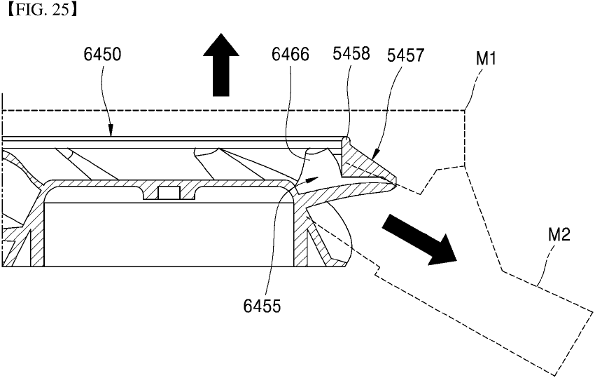

FIG. 24 is a front view showing a slide direction of a mold used for molding the fan of another embodiment, and FIG. 25 is a side cross-sectional view showing the slide direction of the mold in FIG. 24.

In FIG. 25, a side cross-section of the fan is illustrated in a way that one side in the axial direction is an upper portion, and the other side in the axial direction is a lower portion.

Referring to FIGS. 18, 19, 24, and 25, the fan 6450 in the embodiment may be manufactured in a molding manner using a mold. For example, the fan 6450 may be manufactured in an injection molding manner in which a molded product is formed by injecting a plastic material melted by heating into a mold and solidifying or curing the plastic material.

Generally, a molded product like the fan 6450 may be manufactured using a mold divided into two main parts. One of them is a first mold M1 moved in the axial direction of the fan 6450 and engaged with or separated from the other mold. Additionally, the other one is a second mold M2 obliquely moved in a direction between the axial direction, a circumferential direction, and the radial direction of the fan 6450 and engaged with or separated from the first mold.

Although the first mold M1 may be divided into a plurality of molds, the first mold M1 may also be provided as one mold. The second mold M2 needs to be provided as in a way that second molds M2 are divided by as much as at least the number of the fan blades 6455 due to the feature of the fan 6450 in which the plurality of fan blades 6455 are disposed in the circumferential direction of the fan 6450.

Largest differences between the fan 6450 in the embodiment and another fan are the front end projection part 6456 provided on the front end of the fan blade 6455 in the rotation direction and the camber formed on the fan blade 6455.

That is, the fan 6450 in the embodiment is has a complicated shape compared to fans formed in a way that a front end of a fan blade in a rotation direction is formed in a straight line shape and front surfaces and rear surfaces of fan blades have the flat shapes.

When the shape of the fan blade is complicated as described above, there is a high possibility that it is difficult to mold the fan using the mold. For example, there may be a problem that an additional postprocess is required after molding using the mold is completed, or the number of molds increases even when the molding of the fan is completed by only molding using the mold.

Considering the fact, in the embodiment, a design of the shape of the fan blade 6455 is proposed such that shapes like the front end projection part 6456 and the camber are applied to the fan blade 6455 without adding a postprocess or increasing the number of molds.

Accordingly, the front end projection part 6456 protrudes further than the front end reference line L and the shroud chord 5455c toward one side in the axial direction and the front in the rotation direction and does not protrude further than the shroud 5457 toward one side in the axial direction.

In the embodiment, portions such as a front surface of the shroud 5457, a shroud projection 5458, and the fan blade front surface 6455e are molded using the first mold M1, and portions such as the fan blade rear surface 6455f, a rear surface of the shroud 5457, and one region of the fan blade front surface 6455e which overlaps the shroud 5457 in the axial direction are molded using the second molds M2.

When the front end projection part 6456 protrudes further than the shroud 5457 toward one side in the axial direction, it is difficult to mold the fan 6450 using the first mold M1 formed as one mold since it is difficult to mold the shroud projection 5458 extending along a straight line in the axial direction and the front end projection part 6456 protruding at a slat using one mold at the same time.

In consideration of the above fact in the embodiment, the front end projection part 6456 does not protrude further than the shroud 5457 toward one side in the axial direction. To this end, a position of the foremost side projection point 6456a of the front end projection part 6456 in the axial direction may be the same as a position of the shroud 5457 or may be disposed behind the shroud 5457. Additionally, in the front end projection part 6456, a section between the foremost side projection point 6456a of the front end projection part 6456 and the shroud 5457 may be formed in a flat shape perpendicular to a straight line in the axial direction.

As the shape of the front end projection part 6456 is determined as the above shape, in one side region of the fan 6450 in the axial direction molded using the first mold M1, i.e., a region between the front surface of the shroud 5457 and the shroud projection 5458, only a structure, such as, the shroud projection 5458 protruding straightly in the axial direction, is present, and a structure protruding in other directions other than the axial direction is not present. Accordingly, the fan 6450 can be effectively molded even using the first mold M1 formed as the one mold.

Additionally, in the embodiment, the fan blade front surface 6455e and the fan blade rear surface 6455f are formed in the shapes different from each other. That is, the camber is formed on only the fan blade front surface 6455e, and the fan blade rear surface 6455f is formed in the flat shape.

In the embodiment, the second molds M2 are divided by as much as the number of the fan blades 6455, and the second molds M2 are separated independently after the fan 6450 is completely molded.

When the second molds M2 are separated from the fan 6450, each of the second molds M2 is obliquely moved in a direction between the axial direction, the circumferential direction, and the radial direction of the fan 6450. When movement of the second mold M2 in the circumferential direction is ignored, the second mold M2 obliquely moves in a direction between the axial direction and the radial direction of the fan 6450, and a movement direction of the second molds M2 is parallel with a slant angle of the flat surface formed by the fan blade rear surface 6455f.

When the camber is formed on not only the fan blade front surface 6455e but also the fan blade rear surface 6455f, i.e., the fan blade rear surface 6455f is formed in a curved shape that is convex toward the other side in the axial direction, a projection structure which hinders movement of the second mold M2 is present on the fan blade rear surface 6455f.

At this time, the number of the second molds M2 greater than the number of the fan blades 6455 is required, or an additional postprocess is required after molding is completed using the molds when it is difficult to complete the molding through the number of the second molds M2 greater than the number of the fan blades 6455. That is, after the fan blade rear surface 6455f is molded in a flat shape, an additional process of forming a corresponding portion into a curved surface is further required.

In consideration of the above fact in the embodiment, the camber is formed on only the fan blade front surface 6455e, and the fan blade rear surface 6455f is formed in the flat shape. As a result, as the camber is formed on the fan blade 6455, the performance of the fan 6450 at fixed pressure can be improved, and molding using the mold can also be performed without adding a postprocess or increasing the number of molds.

### Operation and Effect of Fan

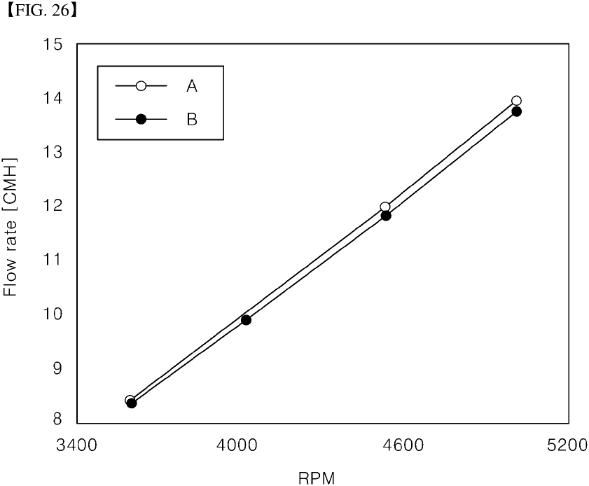

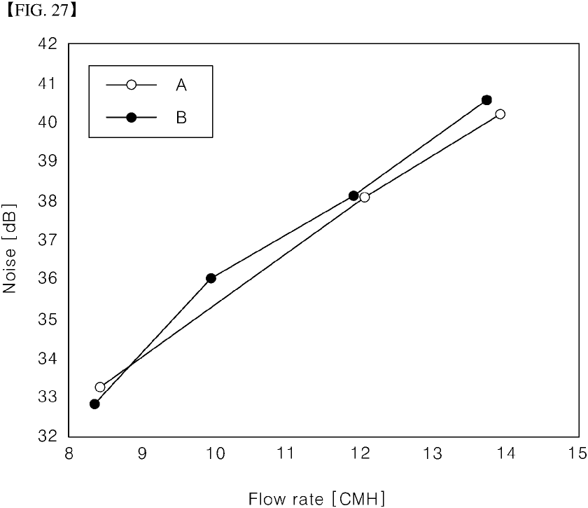

FIG. 26 is a graph showing a measurement result of a flow rate with respect to a fan speed of the portable air purifier of another embodiment, and FIG. 27 is a graph showing a measurement result of a noise with respect to the flow rate of the portable air purifier of another embodiment.

Components other than a fan in a comparative target air purifier illustrated in FIGS. 26 and 27 are the same as those of the air purifier in the embodiment. Additionally, differences between the fan of the comparative target air purifier and the fan of the portable air purifier in the embodiment are a front end projection part not formed on a fan blade of the fan of the comparative target air purifier illustrated in FIGS. 26 and 27 and both a front surface and a rear surface of the fan blade of the fan of the comparative target air purifier formed into flat shapes.

Hereinafter, operation and effects of the portable air purifier in the embodiment will be described with reference to FIGS. 21 to 27.

Referring to FIGS. 21 and 22, the shape of the fan blade 6455 is determined in a way that the area of the region adjacent to the shroud 5457 is greater than the area of the region adjacent to the hub 5451 in the fan blade front surface 6455e. To this end, the front end projection part 6456 is formed on the front end of the fan blade 6455 in the rotation direction.

As the fan blade 6455 is formed in the shape described above, an area of the entire fan blade 6455 increases, and particularly, an area of a region capable of blowing a larger amount of air than another region can also increase.

Accordingly, the discharge performance of the fan 6450 can be improved, and a pressure received by the fan 6450 per unit area can also be reduced while the fan 6450 operates.

Additionally, due to a projection structure formed by the front end projection part 6456 in a way that a part of the fan blade 6455 protrudes, an increase in rigidity of the fan blade 6455 can be expected.

Additionally, in the embodiment, the shape of the fan blade 6455 is designed in a way that the camber is formed on the fan blade front surface 6455e as illustrated in FIG. 23. Accordingly, the rigidity of the fan blade 6455 can be improved, and the performance of the fan 6450 at fixed pressure can also be improved further.

As a result, a portable air purifier A in the embodiment provides improved discharge performance and reduced noise compared to a comparative target air purifier B. That is, the portable air purifier A in the embodiment can provide a higher flow rate than the comparative target air purifier B under a condition that the fan 6450 rotates at the same speed (see FIG. 26) and can provide an effect of generating smaller noise than the comparative target air purifier B at the same flow rate (see FIG. 27).

Meanwhile, referring to FIGS. 21 to 23, the front end projection part 6456 protrudes further than the front end reference line L and the shroud chord 5455c toward one side in the axial direction and the front in the rotation direction and does not protrude further than the shroud 5457, particularly, the shroud projection 5458 toward one side in the axial direction.

The shroud projection 5458 corresponds to a component disposed at the foremost side in the fan 6450 in the axial direction. Accordingly, when the front end projection part 6456 protrudes further than the shroud projection 5458 toward one side in the axial direction, a length of the entire fan 6450 in the axial direction increases as much as the length by which the front end projection part 6456 protrudes further than the shroud projection 5458 toward one side in the axial direction.

When the length of the fan 6450 in the axial direction increases, a size of the entire fan module increases, and thus a size of the entire portable air purifier increases. This is not a preferable change to the portable air purifier in which portability is important.

There may be a method of changing a design of the fan in a way that a size of the entire fan module does not increase. However, in this case, the design should be changed in a way that the length of the fan blade 6455 in the axial direction decreases as much as the length by which the front end projection part 6456 protrudes further than the shroud projection 5458 toward one side in the axial direction. However, when the length of the fan blade 6455 in the axial direction decreases, a contact area of the fan blade 6455 with air decreases as much, and thus there is a problem that the discharge performance of the fan module is degraded.

In consideration of the above fact in the embodiment, as the front end projection part 6456 does not protrude further than the shroud projection 5458 toward one side in the axial direction, an increase in the length of the entire fan 6450 in the axial direction due to the front end projection part 6456 is not allowed. As a result, the portable air purifier in the embodiment can provide an effect of further improved discharge performance without increasing the size of the portable air purifier.

The present invention has been described with reference to embodiments illustrated in the accompanying drawings, but this is merely exemplary. It will be understood by those skilled in the art that various modifications and equivalent other example embodiments may be made from the embodiments of the present invention. Therefore, the scope of the present invention is defined by the appended claims.

### DESCRIPTION OF REFERENCE NUMERALS

50: Portable air purifier
510: Front panel
520: Case
530: Fan cover
531: Upper cover part
532: Upper air discharge part
533: Lower air discharge part
534: First fastening projection
535: Lower cover part
537: Side surface
540: First fan module
545: Second fan module
550: Filter module
551: Filter case
552: Penetration hole
553: Second fastening projection
559: Filter
560: Battery
570: Rear surface panel
580: Rear surface cover
5410: Shaft
5420: Motor
5421: Stator
5423: Rotor
5430: First support part
5430a: Fan outlet
5431: Support plate
5433: Boss
5435: Bearing
5440: Second support part
5441: Fastening hole
5442: Projection boss
5443: Side rib
5445: Third support part
5450,6450: Fan
5451: Hub
5452: Hub plate part
5452a: Shaft coupling part
5453: Skirt part
5454: Inner projection part
5455,6455: Fan blade
5455a: Leading edge
5455b: Trailing edge
5455c: Shroud chord
5455d: Hub chord
5457: Shroud
5458: Shroud projection
5460: Fan base
5461: Base plate
5462: Fan inlet
5463: Bell mouth
5465: Fastening boss
5467: Third fastening projection
6455e: Fan blade front surface
6455f: Fan blade rear surface
6456: Front end projection part
6456a: Foremost side projection point

1. A fan module comprising:
a shaft which extends in an axial direction;
a motor which comprises a stator and a rotor which rotates about the shaft; and
a fan which comprises a hub, a shroud, and a fan blade, wherein the hub rotates along with the rotor and the shaft, the shroud is disposed outside the hub in a radial direction, and the fan blade protrudes from the hub in a centrifugal direction and connects the hub and the shroud,
wherein the fan further comprises a front end projection part which protrudes forward in a rotation direction from a front end of the fan blade in the rotation direction, and
at least a part of the front end projection part protrudes forward in the rotation direction further than a front end reference line which is a straight line which connects a connection point of the front end of the fan blade in the rotation direction and the hub and a connection point of the front end of the fan blade in the rotation direction and the shroud.

2. The fan module of claim 1, wherein the fan blade comprises:
a leading edge which is disposed at the front end in the rotation direction and formed to be straight;
a trailing edge which is disposed at a rear end in the rotation direction and formed to be straight;
a shroud chord which connects one end of the leading edge and one end of the trailing edge and extends in an inner circumferential surface of the shroud; and
a hub chord which connects the other end of the leading edge and the other end of the trailing edge and extends from an outer circumferential surface of the hub,
wherein the front end projection part protrudes from the leading edge and protrudes further forward than the shroud chord in the rotation direction.

3. The fan module of claim 2, wherein:
the shroud chord is obliquely formed with a predetermined slant angle in a way that the shroud chord is disposed at one side in the axial direction from the trailing edge side toward the leading edge side; and
the front end projection part forms a slant angle parallel with the slant angle of the shroud chord and protrudes from the leading edge.

4. The fan module of claim 1, wherein the front end projection part is disposed in a way that a foremost side projection point of the front end projection part is closer to the shroud than the hub.

5. The fan module of claim 4, wherein the front end projection part protrudes further toward the one side in the axial direction as being closer to the foremost side projection point of the front end projection part from the other end side of the leading edge.

6. The fan module of claim 5, wherein the front end projection part is formed in a way that the other end of the leading edge and the foremost side projection point of the front end projection part are roundly connected.

7. The fan module of claim 4, wherein the front end projection part is formed in a shape in which a ratio of a distance between the foremost side projection point of the front end projection part and the hub and a distance between the foremost side projection point of the front end projection part and the shroud is in the range of 3:1 to 5:1.

8. The fan module of claim 2, wherein:
the fan blade comprises a fan blade front surface and a fan blade rear surface each connecting the leading edge and the trailing edge;
the fan blade front surface is disposed further forward than the fan blade rear surface in the rotation direction; and
the fan blade front surface and the fan blade rear surface are formed in shapes different from each other.

9. The fan module of claim 8, wherein:
the fan blade front surface is formed in a shape which connects the leading edge and the trailing edge using a curved surface that is convex toward one side in the axial direction; and
the fan blade rear surface is formed in a shape which connects the leading edge and the trailing edge straightly.

10. A portable air purifier comprising:
a case in which a suction surface is disposed at one side in an axial direction and a discharge surface is disposed at the other side in the axial direction;
a filter disposed between the suction surface and the discharge surface; and
a fan module disposed between the discharge surface and the filter,
wherein the fan module comprises:
a shaft which extends in the axial direction;
a motor which comprises a stator and a rotor which rotates about the shaft; and
a fan which comprises a hub, a shroud, and a fan blade, wherein the hub rotates along with the rotor and the shaft, the shroud is disposed outside the hub in a radial direction, and the fan blade protrudes from the hub in a centrifugal direction and connects the hub and the shroud,
the fan further comprises a front end projection part which protrudes forward in a rotation direction from a front end of the fan blade in the rotation direction, and
at least a part of the front end projection part protrudes forward in the rotation direction further than a front end reference line which is a straight line which connects a connection point of the front end of the fan blade in the rotation direction and the hub and a connection point of the front end of the fan blade in the rotation direction and the shroud.
